(19) United States
(12) Patent Application Publication
(10) Pub. No.: US 2016/0212690 A1
(43) Pub. Date: Jul. 21, 2016

(54) Method and System for Cooperative Acquisition of Network Access Information

(71) Applicant: QUALCOMM Incorporated, San Diego, CA (US)

(72) Inventors: Aritra Ukil, Hyderabad (IN); Anand Rajurkar, Hyderabad (IN); Soumen Mitra, West Bengal (IN); Vijay Anandrao Suryavanshi, San Diego, CA (US); Giridhar Dhati Mandyam, San Diego, CA (US)

(21) Appl. No.: 14/600,071

(22) Filed: Jan. 20, 2015

(51) Int. Cl. H04W 48/16

(52) U.S. Cl. CPC H04W 48/16; H04W 84/10

(57) ABSTRACT

Methods, systems and wireless communication devices are provided for maintaining wide area network (WAN) access information in a database accessible to a local area network (LAN) server. A processor of a wireless communication device connected to the LAN determines that the wireless communication device will enter a WAN associated with the WAN access information. The wireless communication device processor may obtain the WAN access information from the LAN accessible database accessible to the LAN server. The wireless communication device processor may use the WAN access information obtained from the LAN accessible storage device to enter the WAN from the LAN.

### BACKGROUND

In the Internet of things (IoT), mobility is a key factor. Mobile user equipment (UE) wireless communication devices may move between networks. For example, UE wireless communication devices may move back and forth between a Wide Area Network (WAN), such as a cellular telephone network, and a Local Area Network (LAN), such as an IoT network. UE wireless communication devices must acquire network parameters and other access information when moving between networks. For example, a UE wireless communication device may acquire or reacquire WAN access information when leaving a LAN, because the WAN access information may have changed since the previous connection with the WAN. A WAN/cellular network may be an LTE or GSM network, and a LAN may be a WiFi network supporting multiple wireless communication devices. Since UE wireless communication devices may receive data services (including VoIP) over a LAN more affordably or efficiently than a WAN/cellular network, wireless communication devices may turn off their WAN/cellular network transceiver when connected to a LAN in order to conserve battery power and to conserve data connection costs associated with the WAN/cellular network. However, upon moving from the LAN to a WAN/cellular network, difficulties arise related to reacquisition of WAN/cellular access information needed to establish a connection.

Because a wireless communication device may not be using WAN services while connected to the LAN, shutting down the connection to the WAN provides an advantage of conserving battery power. However, when a wireless communication device moves from a WAN to a LAN and shuts down the transceiver, the reception of access related overhead information from the WAN may also be terminated. When the wireless communication device returns to the WAN/cellular network, such as when the wireless communication device moves out of LAN reception range, the wireless communication device may be required to perform a reacquisition procedure, which begins with acquisition of overhead information (e.g., MIB, SIB, in a WCDMA/LTE system) needed to establish a cellular or WAN connection.

Thus, a wireless communication device that enters a LAN may shut down a transceiver for WAN/cellular network access. The wireless communication device may later re-enter a WAN/cellular network and must perform a full acquisition sequence in order to re-attach to the WAN/cellular network. The reacquisition of WAN/cellular network access data may take time and power, which may be disadvantageous. A full system information re-acquisition may delay the wireless communication device attachment to the WAN/cellular network and may thereby delay the use of data apps, etc. In some situations, the reacquisition delay may adversely impact the continuity and quality of the user experience.

### SUMMARY

In the various embodiments, wide area network (WAN) access information maintained in a database accessible to a local area network (LAN) server may be used to assist wireless communication devices in connecting to the WAN. An embodiment method may include determining, by a processor of a wireless communication device connected to the LAN, that the wireless communication device will leave the LAN to enter a WAN associated with the WAN access information. The processor of the wireless communication device may obtain the WAN access information from the LAN accessible database accessible to the LAN server. The processor of the wireless communication device may use the WAN access information obtained from the LAN accessible storage device to enter the WAN from the LAN.

An embodiment method may further include providing by the wireless communication device processor to the LAN server, upon entering the LAN from the WAN, WAN access information used by the wireless communication device in the WAN before entry into the LAN from the WAN. The LAN server may store, in the LAN accessible database, the WAN access information used by the wireless communication device in the WAN before the wireless communication devices enters into the LAN. An embodiment method may further include providing, by the wireless communication device processor to the LAN server, a subscription message that enables the wireless communication device processor to receive updates to the stored WAN access information. An embodiment method may further include receiving, by the LAN server, from wireless communication devices entering the LAN from the WAN, respective WAN access information for the wireless communication devices. The LAN server may store recent WAN access information received from the wireless communication devices entering the LAN from the WAN in the LAN accessible database. An embodiment method may further include determining, by the LAN server, whether the WAN access information most recently received from the wireless communication devices entering the LAN from the WAN differs from WAN access information stored by the LAN server in the LAN accessible storage device. The LAN server may provide the most recently received WAN access information to one or more of the wireless communication devices in response to determining that the recent WAN access information differs from the WAN access information stored in the LAN accessible database. An embodiment method may further include receiving, by the LAN server from one or more of the wireless communication devices entering the LAN, a subscription message indicating that the one or more of the wireless communication devices will receive a notification of an update of the WAN access information stored in the LAN accessible database. The LAN server may provide the notification of the update of the WAN access information stored in the LAN accessible database to the one or more of the wireless communication devices from which the subscription message is received in response to determining that the most recently received WAN access information differs from the WAN access information stored in the LAN accessible database. An embodiment method may further include determining, by the LAN server, whether the WAN access information recently received from the wireless communication devices entering the LAN from the WAN differs from WAN access information stored by the LAN server in the LAN accessible storage device. The LAN server may store the recently received WAN access information in the LAN accessible database in response to determining that the recent WAN access information differs from the WAN access information stored in the LAN accessible database.

In a further embodiment method, the WAN access information may include one or more of: a Master Information Block (MIB); a System Information Block (SIB); and an overhead (OVHD) block. In a further additional or alternative embodiment method, the WAN access information includes WAN access overhead information.

The various embodiments include a wireless communication device having a device radio module, a device memory and a device processor configured with processor executable instructions to perform operations of the above described embodiment methods. The various embodiments include a wireless communication device having means for performing functions of the operations of the above-described embodiment methods. The various embodiments include a non-transitory processor readable medium may have instructions stored thereon configured to cause a processor to perform operations of the above described embodiment methods.

The various embodiments include a LAN server having a server radio module, a server memory and a server processor configured with processor executable instructions to perform operations of the above described embodiment methods. The various embodiments include a LAN server having means for performing functions of the operations of the above-described embodiment methods. The various embodiments include a non-transitory processor readable medium may have instructions stored thereon configured to cause a processor to perform operations of the above described embodiment methods.

The various embodiments include a system having a wireless communication device having a device radio module, a device memory and a device processor, and a LAN server having a server radio module, a server memory and a server processor, the device processor and the server processor may be configured with processor executable instructions to perform operations of the above described embodiment methods. The various embodiments include a wireless communication device and a LAN server having means for performing functions of the operations of the above-described embodiment methods. The various embodiments include a non-transitory processor readable medium may have instructions stored thereon configured to cause a processor to perform operations of the above described embodiment methods.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a diagram illustrating a user equipment (UE) wireless communication device moving between a wide area network (WAN) and a local area network (LAN) and reacquiring a WAN after leaving a LAN.

FIG. 2A is a diagram illustrating network components including UE wireless communication devices, a LAN, a LAN server, a LAN-accessible storage device and a database in the various embodiments.

FIG. 2B is a diagram illustrating a first UE wireless communication device moving from a first WAN to a LAN and storage of first WAN access information of a first UE wireless communication device in a LAN-accessible storage device and database in the various embodiments.

FIG. 2C is a diagram illustrating a second UE wireless communication device moving from a first WAN to a LAN and updating of first WAN access information of a second UE wireless communication device in a LAN-accessible storage device and database in the various embodiments.

FIG. 2D is a diagram illustrating a third UE wireless communication device moving from a second WAN to a LAN and updating of a second WAN access information of a third UE wireless communication device in a LAN-accessible storage device and database in the various embodiments.

FIG. 2E is a diagram illustrating a first UE wireless communication device moving from a LAN to a WAN using updated WAN access information of a second UE wireless communication device obtained from a LAN-accessible storage device and database in the various embodiments.

FIG. 3A is a message flow diagram illustrating operations associated with providing WAN access information to a LAN access point, LAN-accessible storage device and database, storing WAN access information, and a UE wireless communication device using WAN access information stored in the LAN accessible database to reenter the WAN in the various embodiments.

FIG. 3B is a message flow diagram further illustrating operations associated with providing WAN access information to a LAN access point, LAN-accessible storage device and database, storing WAN access information, and a UE wireless communication device using WAN access information stored in the LAN accessible database to reenter the WAN in the various embodiments.

FIG. 4A is a message flow diagram illustrating alternative or additional operations associated with providing WAN access information to a LAN access point, LAN-accessible storage device and database, updating WAN access information, and providing WAN access information updates to UE wireless communication devices in the various embodiments.

FIG. 4B is a message flow diagram further illustrating alternative or additional operations associated with providing WAN access information to a LAN access point, LAN-accessible storage device and database, updating WAN access information, and providing WAN access information updates to UE wireless communication devices in the various embodiments.

FIG. 5A is a process flow diagram illustrating an embodiment method having operations including providing WAN access information to a LAN and storing the WAN access information in a LAN accessible storage device.

FIG. 5B is a process flow diagram illustrating an embodiment method having operations including providing WAN access information to a LAN when an additional wireless communication device enters a LAN and storing or updating the WAN access information in a LAN accessible storage device.

FIG. 5C is a process flow diagram illustrating an embodiment method having operations including requesting WAN access information from a LAN when a UE wireless communication device leaves a LAN and providing updated WAN access information to the UE wireless communication device for WAN reentry.

FIG. 5D is a process flow diagram illustrating an embodiment method having operations including sending a subscription message to a LAN and receiving notifications of updated WAN access information.

FIG. 6A is a process flow diagram illustrating an embodiment method having operations including a LAN Access Point that receives WAN access information from a UE wireless communication device and storing WAN access information in a LAN-accessible storage device.

FIG. 6B is a process flow diagram further illustrating an embodiment method having operations including a LAN Access Point that receives WAN access information from UE wireless communication devices, storing WAN access information in a LAN-accessible storage device, and providing updates to UE wireless communication devices for WAN access information.

FIG. 6C is a process flow diagram further illustrating an embodiment method having operations including a LAN Access Point that receives WAN access information and a subscription message from UE wireless communication devices and providing updates for WAN access information to UE wireless communication devices from which subscription messages received.

FIG. 7 is a component diagram of an example wireless communication device in the form of mobile computing wireless communication device suitable for use with the various embodiments.

FIG. 8 is a component diagram of an example wireless communication device in the form of tablet computer suitable for use with the various embodiments.

FIG. 9 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments facilitate the acquisition of Wide Area Network (WAN) access information to support connections with a WAN by a wireless communication device, such as a User Equipment (UE), that enters the WAN from a Local Area Network (LAN) to which the device is or was connected. In various embodiments, the UE wireless communication device may request or otherwise obtain WAN access information, which may include information such as overhead information necessary for “acquiring” and establishing a connection with the WAN. Examples of WAN access information include a Master Information Block (MIB) or blocks, a System Information Bock (SIB) or blocks, and overhead information (OVHD). The WAN access information may be obtained when it is detected that the wireless communication device is leaving the LAN and entering the WAN. Detection that the wireless communication device is leaving the LAN and the WAN may occur automatically when the wireless communication device detects that the signal strength associated with the LAN signal is reducing. The conditions normally associated with re-energizing the WAN RF module may also be used to obtain the WAN access information. The WAN access information may be obtained before the LAN RF module is shut down or the LAN signal is lost. The wireless communication device may further receive input from a user of the wireless communication device indicating that the user intends to enter (or re-enter) the WAN and leave the LAN.

In other embodiments, a LAN access point may detect when the strength of wireless signals from the wireless communication device is degrading, indicating that the wireless communication device may be leaving the range of the LAN. Upon detecting that the wireless communication device may be leaving the LAN, the LAN access point may automatically provide the WAN access information to the wireless communication device. The LAN access point may provide recent WAN access information from a LAN accessible storage device. The recent WAN access information may be received and stored by the LAN access point from wireless communication devices that enter the LAN. For example, as wireless communication devices enter the LAN over time, the WAN access information may be received by the LAN access point from these wireless communication devices.

The LAN access point may automatically store the WAN access information for the wireless communication device that enters the LAN most recently. Alternatively, the LAN may determine whether recently received WAN access information represents a change of WAN access information. For example, if the WAN access information received from the wireless communication device that most recently entered the LAN differs from WAN access information stored in the LAN accessible database, the LAN access point may overwrite the WAN access information with the most recently received information. In some embodiments, the LAN may provide or “push” the most recent information as an update to one or more wireless communication devices within the LAN when the WAN access information changes. Alternatively, recent WAN access information may be provided to one or more wireless communication devices when the wireless communication device or wireless communication devices leave the LAN.

In various embodiments, the WAN access information may be stored in a LAN/IoT-accessible database (i.e., a database maintained in a computing device within the LAN that is accessible via the LAN or an IoT network), a cloud-based database, or another database maintained in a network-accessible storage device, such as a cloud storage device. The database and/or storage device may be accessible via the LAN, such as through a node or an access point for the LAN, and wireless communication devices within the LAN may access the storage device. The LAN/IoT-accessible database may store the latest WAN/cellular network access information. The latest information may be obtained by wireless communication devices leaving the LAN in order to acquire or reacquire WAN/cellular network service. The database may be updated by wireless communication devices reporting their WAN/cellular network access/overhead information as they enter the LAN. The reporting of WAN/Cellular access information may be accomplished as part of a process of registering with the LAN, receiving the access information and storing/updating the database with the access information. A LAN component that has access to the database, such as a LAN node, a LAN server, and/or LAN access point, receives the WAN/cellular network access information from each arriving wireless communication device. The LAN node, access point, or other component may determine whether the information has changed by comparing the received WAN access information with previously stored WAN access information. If the received WAN access information differs from the WAN access information saved in the database, the database may be updated. The wireless communication devices in the LAN may be notified that the database has been updated. The notification may enable the wireless communication devices to obtain the updated information when necessary (e.g., when leaving the LAN and re-entering the WAN). Alternatively or in addition, the notification may include the updated information. The updated information can then be used by wireless communication devices when leaving the LAN and re-entering the WAN/cellular network for expediting reacquisition, thereby saving power and improving the user experience.

In the various embodiments, the LAN/IoT-accessible database may be indexed by radio access technology (RAT) and service provider, which may be collectively referred to herein as the “WAN system.” The access information stored in the database may include overhead information that is relevant for the particular system so that wireless communication devices may obtain WAN/cellular network access/overhead information that is relevant to their RAT and provider. Further, when the database is updated for a particular WAN system (e.g., RAT and provider), those wireless communication devices configured to use that system (e.g., those wireless communication devices reporting access information for that WAN system upon entering the LAN) may be notified of the updates.

More specifically, when a UE wireless communication device enters the LAN, it may register with the LAN or the LAN/IoT-accessible database. The wireless communication devices, (UE₁. . . n) may register their radio access technology (RAT), examples of which include LTE, CDMA, WCDMA, and GSM. The wireless communication devices may also register their service provider (SP) information, examples of which include Verizon and AT&T. The wireless communication devices may transmit to the LAN/IoT-accessible database the latest WAN/cellular network access/overhead information (e.g., MIB, SIB, OVHD, for LTE systems).

As discussed above, the WAN access information may be updated in the database as wireless communication devices join and registered with the LAN, and the wireless communication devices in the LAN may receive a notice that the database has been updated for its RAT and SP. When a wireless communication device leaves the LAN, if it had received a notice that the database had been updated it may access the database to obtain the information needed to reacquire the WAN/cellular network for the specific SP/RAT for the wireless communication device. If it does not receive a notice that the database has been updated, the wireless communication device may use the WAN/cellular network access information stored in its local memory or cache. Alternatively, rather than accessing the database of WAN access information upon leaving the LAN, wireless communication devices may access the database to obtain updated information in response to being notified of a database update. Further, in lieu of a notification or in addition to a notification, a wireless communication device such as an access point or controller may “push” the updated WAN access information to the wireless communication devices whenever an update has been received.

In some embodiments, the UE wireless communication devices may access the database via the LAN to acquire the updated WAN/cellular data network access/overhead information in response to receiving an update notification. The UE wireless communication devices may store the updated WAN/cellular data network access/overhead information in wireless communication device memory for use when leaving the LAN and accessing the cellular data network.

As used herein the term “LAN” may refer to a technology or group of technologies, protocols, physical connections, and other mechanisms that enable communications between wireless communication devices in a network environment.

As used herein, the term “range” “maximum range,” “adjusted range” may all refer to an approximate distance over which radio signals may be transmitted, or received. The range of a transmitter may be dependent on various environmental conditions existing in the radio environment. Therefore, while the term “range” and its analogs may be used herein in connection with distance, transmit power, and received power, the term range may not be susceptible to exact measurement. Therefore, range may refer to an average distance over which radio signals may be transmitted, or received by wireless communication devices in the radio environment.

The various embodiments may be implemented using a variety of wireless communication devices and wireless communication device configurations in a radio environment, such as wireless communication devices. The wireless communication devices may be smartphones, tablets, smart appliances, retail hot spots, etc. In the examples described herein, smartphones are used for illustrative purposes. However, other wireless communication devices may be used in the various embodiments.

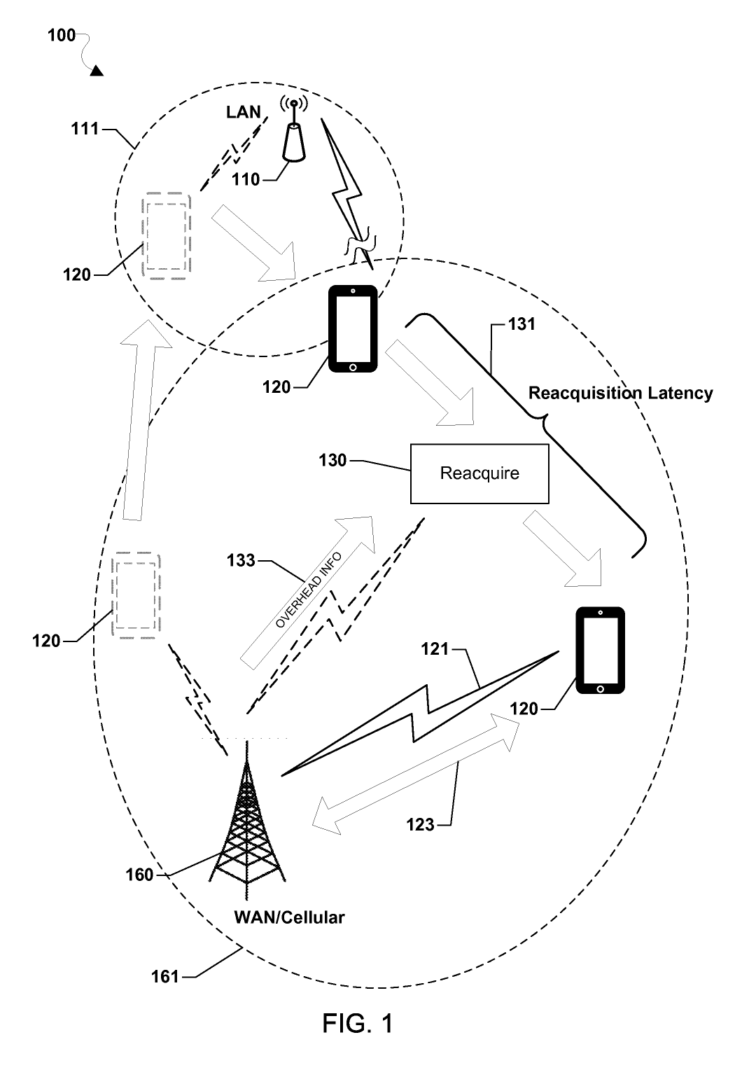

A communication environment 100 including a local area network (LAN) 111 and a wide area network (WAN) 161 is illustrated in FIG. 1A. In various embodiments, a user equipment (UE) wireless communication device 120, which in the illustrated example may be a smartphone, may be positioned to establish communication with the WAN 161, such as through cellular infrastructure component 160. During the course of mobility, the UE wireless communication device 120 may move into the LAN 111. For example, the UE wireless communication device 120 may come within radio signal range of the LAN 161 and an access wireless communication device 110, such as a wireless access point associated with the LAN 161. In other embodiments, the UE wireless communication device 120 may alternatively or additionally establish D2D communications with other UE wireless communication devices 120 (not shown), such as through a communication framework. Upon or after entry into the LAN 111, the wireless communication device 120 may disable or de-energize the radio module for maintaining communication with the WAN 161. By disabling the WAN radio module, the UE wireless communication device 120 may fail to receive updates associated with access information for acquiring access to the WAN 161.

After a period of time, the wireless communication device 120 may re-enter the WAN 161. For example, the UE wireless communication device 120 may move out of range of the LAN 111. The UE wireless communication device 120 may re-energize the WAN radio module when a degradation of the LAN signal is detected. In other embodiments, the user of the UE wireless communication device 120 may manually configure the UE wireless communication device 120 to re-enable or re-energize the WAN radio module when the user intends to leave the LAN 111. The UE wireless communication device 120 begins to receive signals including information such as overhead information 133 from the WAN 161. The UE wireless communication device 120 may receive the overhead information 133 from a dedicated channel associated with the radio access technology of the WAN 161 without actually establishing a user connection with the WAN 161.

The reception of the overhead information 133 may enable the UE wireless communication device 120 to conduct a reacquisition procedure 130. The reacquisition procedure 130 may involve identifying channels and information blocks and other information from the overhead information 133 for establishing a connection with the WAN 161. The reacquisition procedure 130 may involve a reacquisition latency period 131. The reacquisition latency period 131 may be long enough to disadvantageously impact an existing session, such as a data or voice session that was established while the UE wireless communication device 120 was connected to the LAN 111. The reacquisition latency period 131 may therefore adversely impact a user experience for the user of the UE wireless communication device 120 and possibly other parties with whom the user is interacting. When the reacquisition period 131 is completed, the UE wireless communication device 120 will have a connection 121 with the WAN 161 and bidirectional communication 123 may be conducted.

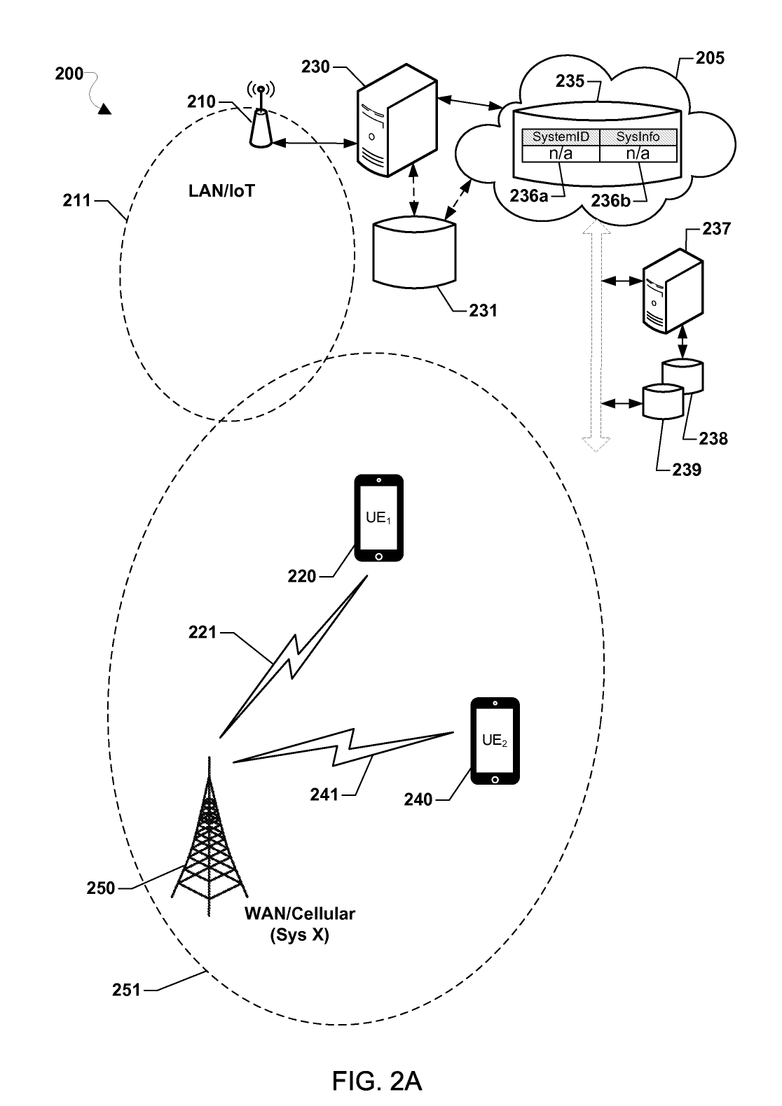

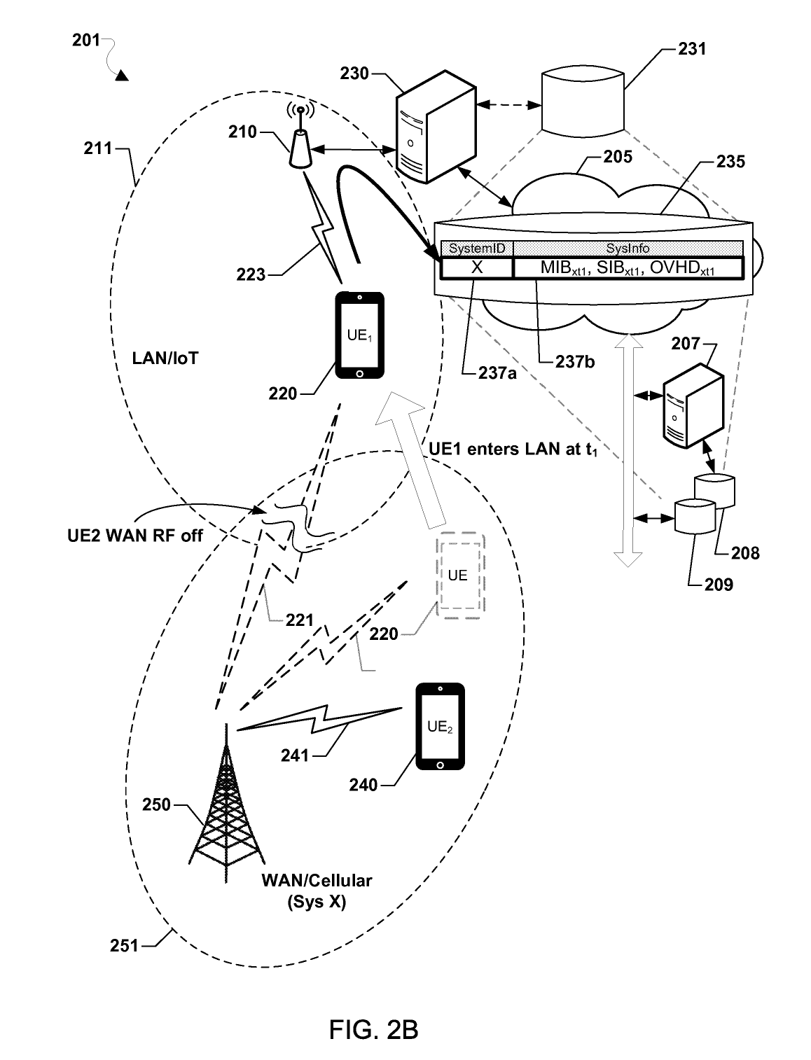

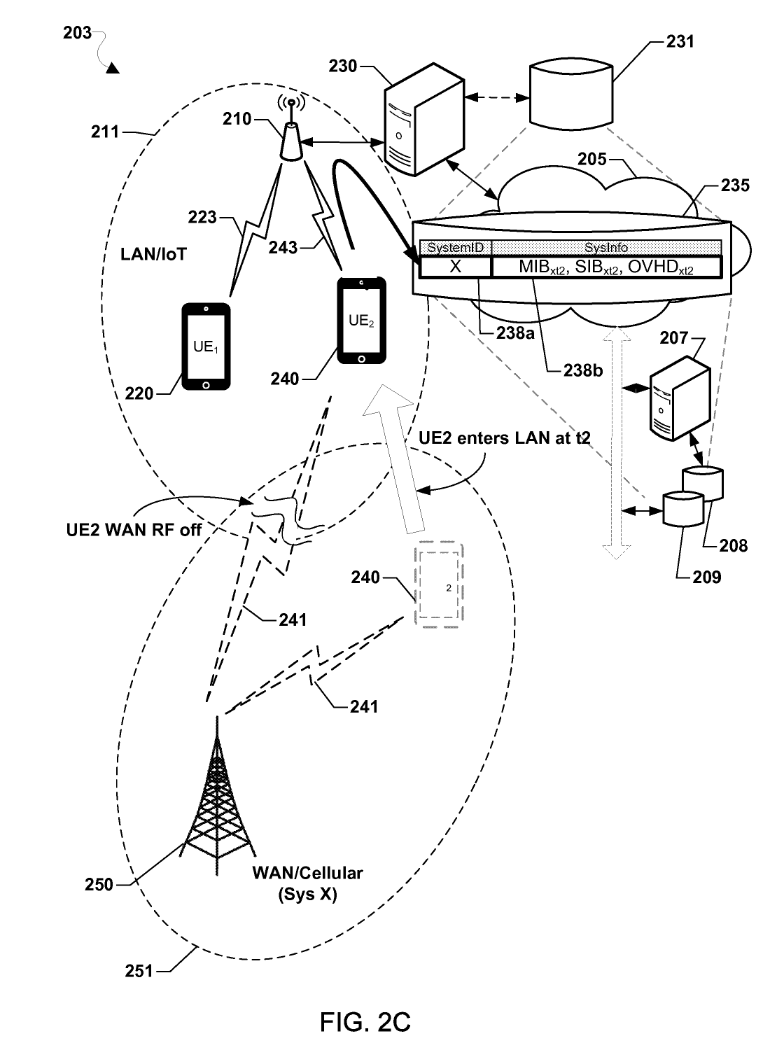

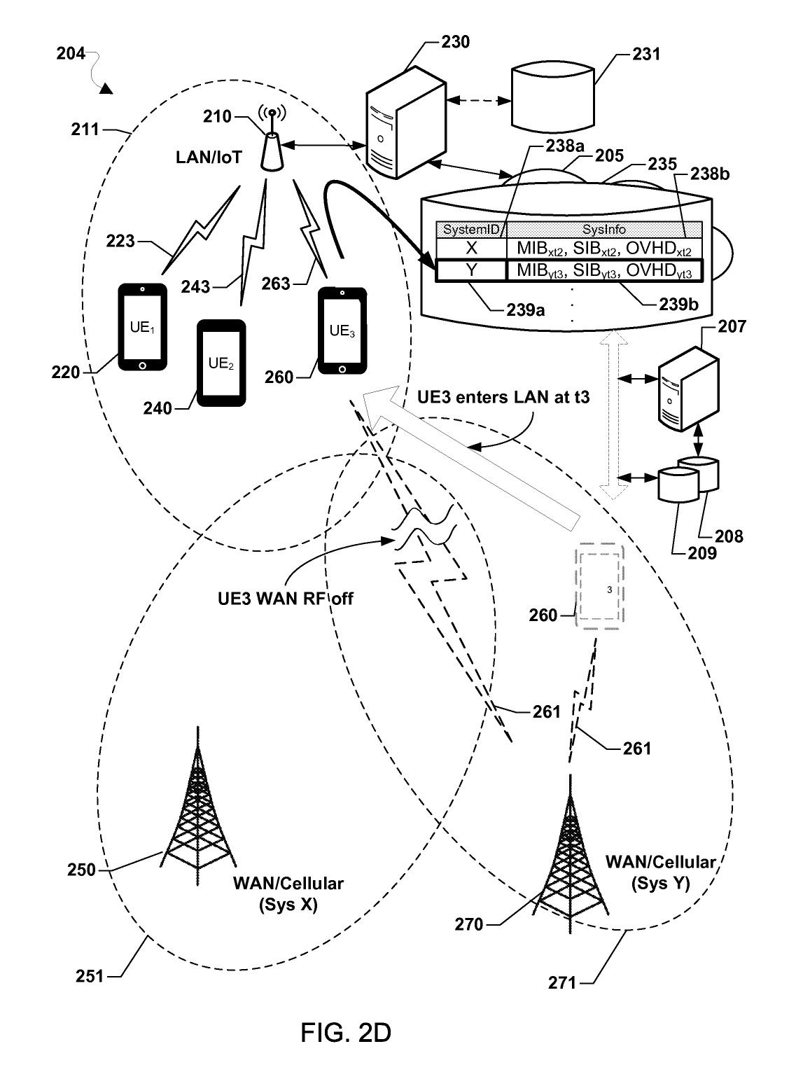

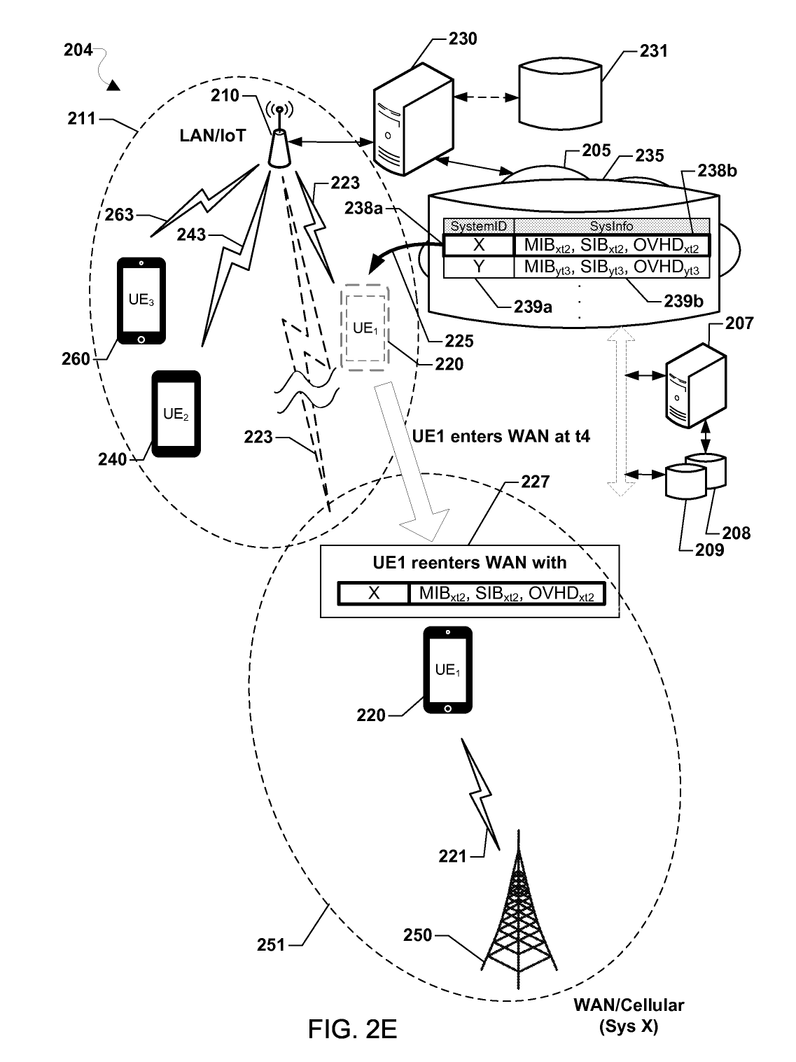

In the various embodiments, the reacquisition latency 131 may be reduced or eliminated by the storage and retrieval of WAN access information from a LAN/IoT-accessible data storage mechanism as illustrated in FIG. 2A-FIG. 2E. As illustrated in FIG. 2A, a UE wireless communication device 220 (UE₁) and a UE wireless communication device 240 (UE₂) may be present within and connected to a wide area network (WAN) 251 through respective connections 221 and 241. The WAN 251 may be associated with an infrastructure component 250 having a particular radio access technology (RAT) and a particular service provider, which may be referred to as a System X. The wireless communication devices may be capable of mobility that will bring them into range of a local area network (LAN) 211, which may be associated with an access wireless communication device 210 such as a wireless access point, or other wireless communication device. In one example, the LAN 211 may be associated with an IoT network, e.g., a network of proximal wireless communication devices that are connected through a communication framework that allows “hardware agnostic” communication between wireless communication devices within proximity to each other.

In the various embodiments, the LAN 211, including the access wireless communication device 210, or the wireless communication devices within the LAN 211, may be capable of communicating with a server 230. The server 230 may be coupled to a storage device 231. Alternatively or additionally, the server 230 may be coupled to other wireless communication devices through a connection, such as an Internet or network connection to a cloud 205. The server 230 may be connected through the cloud 204 to wireless communication devices, such as a server 237, which may be coupled to a storage device 238, and a storage device 239. In various embodiments, the storage device 231 may also be a “cloud” storage device. One of skill in the art will appreciate that reference to “cloud storage” generally refers to wireless communication devices, services, and other capabilities whose location can be flexible, scalable, shared, changeable, distributed, relocatable and so on. Accordingly, reference is made herein to a LAN accessible storage device or database, which can be located locally or externally, or a combination of locally and externally, including “in the cloud.”

In the various embodiments, the server 230 may have access to a database 235, which may be located on one or a combination of the storage devices 231, 238, 239 or other storage elements accessible to the server 230. Regardless of the physical location, the database 235 may be accessible to the LAN 211, such as any of the components of the LAN or, in some cases, the UE wireless communication devices as well. The database 235 may be configured to store WAN access information, such as a System ID entry 236a and a System Info entry 236b. The System ID entry 236a and the System Info entry 236b may represent stored entries of WAN access information for UE wireless communication devices that enter the LAN 251 from a WAN, such as the WAN 251. In the illustrated state, the UE wireless communication devices UE₁ 220 and UE₂ 240 are located within the WAN 251 and not within the LAN 211. Therefore, in an initial state presented for illustrative purposes, the System ID entry 236a and the System Info entry 236b are both empty.

With reference to FIG. 2B, during mobility, the UE wireless communication device UE₁ 220 may move within the range of the LAN 211 at time t₁. The UE wireless communication device UE₁ 220 may establish a connection 223 with the access wireless communication device 210. The UE wireless communication device UE₁ 220 may de-energize the RF module or transceiver responsible for maintaining communication with the WAN 251, which breaks the connection 221 with the WAN infrastructure component 250 associated with System X. Upon entering the LAN 211, the UE wireless communication device UE₁ 220 may provide recent WAN access information for accessing the WAN 251 to the access wireless communication device 210. In some embodiments, the UE wireless communication devices may “register” with one or more of the server 230, the database 235, or other LAN accessible or LAN-related components, by providing system information and WAN access information. In the various embodiments, the WAN access information of the UE wireless communication device UE₁ 220 may be provided to the server 230. The WAN access information may be stored in the database 235 as an entry 237a for a SystemID of “X” and an entry 237b for a SystemInfo of “MIBxt₁, SIBxt₁, OVHD xt₁.” The SystemInfo entry in the present example is illustrative in nature and may represent system information for a particular type of RAT for the system X. Other overhead information may be possible depending on the type of system and the provider of the system (e.g., RAT, particular service provider, etc.).

With reference to FIG. 2C, during mobility, the UE wireless communication device UE₂ 240 may move within the range of the LAN 211 at time t₂. The UE wireless communication device UE₂ 240 may establish a connection 243 with the access wireless communication device 210. The UE wireless communication device UE₂ 240 may de-energize the RF module or transceiver responsible for maintaining communication with the WAN 251, which breaks the connection 241 with the WAN infrastructure component 250 associated with System X. At time t₂, both the UE wireless communication device UE₁ 220 and the UE wireless communication device UE₂ 240 from WAN 251 (System X) are within the LAN 211. In some embodiments, the WAN access information may change from t₁ to t₂. Thus, at least some of the WAN access information stored in connection with the entry of the UE wireless communication device UE₁ 220 into the LAN 211, e.g. System Info entry 237b, may no longer be valid. Upon entering the LAN 211, the UE wireless communication device UE₂ 240 may provide recent WAN access information for accessing the WAN 251 to the access wireless communication device 210. The WAN access information of the UE wireless communication device UE₂ 240 may be provided to the server 230. The WAN access information may be stored in the database 235 as an entry 238a for a SystemID of “X” and an entry 238b for a SystemInfo of “MIBxt₂, SIBxt₂, OVHD xt₂.” In some embodiments, the server 230 may be configured to store or “overwrite” any WAN access information from UE wireless communication devices joining the LAN 211 to ensure that the information is always current. In other embodiments, the server 230 may make a determination as to whether the WAN access information from a UE wireless communication device entering the LAN 211 has changed and may update the WAN access information stored in the LAN accessible database only when a change to the WAN access information is detected.

With reference to FIG. 2D, a UE wireless communication device UE3 260 may move within the range of the LAN 211 from a different WAN, such as WAN 271 (System Y), at time t₃. The UE wireless communication device UE3 260 may establish a connection 263 with the access wireless communication device 210. The UE wireless communication device UE3 260 may de-energize the RF module or transceiver responsible for maintaining communication with the WAN 271, which breaks the connection 261 with the WAN infrastructure component 270 associated with System Y. At time t₃, the UE wireless communication device UE₁ 220 and the UE wireless communication device UE₂ 240 from WAN 251 (System X) and the UE wireless communication device UE3 260 from WAN 271 (System Y) are within the LAN 211. In some embodiments, particularly for a UE wireless communication device entering the LAN from a WAN system not previously encountered, the WAN access information may change or new WAN access information may become available from t₁ or t₂ to t₃. Thus, the WAN access information for WAN 251 (System X) stored in connection with the entry of the UE wireless communication device UE₂ 240 into the LAN 211, e.g., the System ID entry 238a and the System Info entry 238b, may remain valid, while the new information for the UE wireless communication device UE3 260 may be stored. Upon entering the LAN 211, the UE wireless communication device UE3 260 may provide its WAN access information for accessing the WAN 271 to the access wireless communication device 210. The WAN access information of the UE wireless communication device UE3 260 may be provided to the server 230. The WAN access information may be stored in the database 235 as an entry 239a for a SystemID of “Y” and an entry 239b for a SystemInfo of “MIByt₃, SIByt₃, OVHD yt₃.” As with the previously described embodiments, the server 230 may be configured to store or “overwrite” any WAN access information stored in the LAN accessible database with information from UE wireless communication devices for System Y that join the LAN 211 after the UE wireless communication device UE3 260 to ensure that the System Y information is always current. In other embodiments, the server 230 may determine whether the System Y WAN access information from a UE wireless communication device entering the LAN 211 has changed and may update the stored System Y WAN access information only when a change is detected.

The storage of WAN access information facilitates the rapid and efficient reacquisition of a WAN by a mobility UE wireless communication device when re-entering a WAN from a LAN. As illustrated in FIG. 2E, the UE wireless communication device UE₁ 220 may re-enter the WAN 251 (System X) at time t₄, which may be a later time than times t₁-t₃. Before re-entering the WAN 251, the UE wireless communication device UE₁ 220, components of the LAN 211, such as the access wireless communication device 210, or a combination of wireless communication devices may determine that the UE wireless communication device UE₁ 220 is leaving the LAN 211. For example, the UE wireless communication device UE₁ 220 may detect that the signal strength of the LAN 211 is decreasing. Alternatively or additionally, the access wireless communication device 210 may detect that the signal strength from the UE wireless communication device UE₁ 220 is decreasing. Further, the user of the UE wireless communication device UE₁ 220 may select the WAN 251 from a user interface or settings menu in order to manually configure the UE wireless communication device UE₁ 220 to gain access to the WAN 251. When the UE wireless communication device UE₁ 220 determines that it is leaving the LAN 211, but before the connection 223 with the LAN 211 is lost, the UE wireless communication device UE₁ 220 may obtain the latest WAN access information for the WAN 251 from the database 235. For example, the UE wireless communication device UE₁ 220 may obtain the System Info 238b for the System ID entry 238a for System X to which it will enter. Thus, the UE wireless communication device UE₁ 220 obtains WAN access information 237, which becomes the most recent information stored in the database 235.

In various embodiments, the LAN 211 may determine whether access information has changed and may provide or “push” the updated WAN access information to some or all wireless communication devices within the LAN 211. The UE wireless communication devices may store the updates to ensure that they have the most recent WAN access information in the event they re-enter the WAN. In some embodiments, the UE wireless communication devices may receive WAN access information for all of the WANs (e.g., all systems) that have entries. In other words, a UE wireless communication device may enter the LAN from one WAN and leave the LAN to enter a different WAN. In other embodiments, the LAN 211 may provide or “push” any WAN access information that is provided from wireless communication devices that enter the LAN 211. In such an example, the UE wireless communication devices may maintain the latest WAN access information. In some embodiments, the UE wireless communication devices may request updates of WAN access information from the database 235. The updates may be requested periodically, or may be requested when imminent WAN re-entry or a likelihood of imminent WAN reentry is detected. A combination of conditions for providing WAN access information, or other approaches are possible. For example, the server 230, server 207, database 235 may provide the WAN access information to the UE wireless communication device or wireless communication devices in response to a request received from a UE wireless communication device. Alternatively or in addition, the WAN access information may be provided to the UE wireless communication device or wireless communication devices based on a condition such as a signal level from a UE wireless communication device. Alternatively or in addition, the WAN access information may be provided to the UE wireless communication device or wireless communication devices periodically such as when the WAN access information is updated or according to a time period.

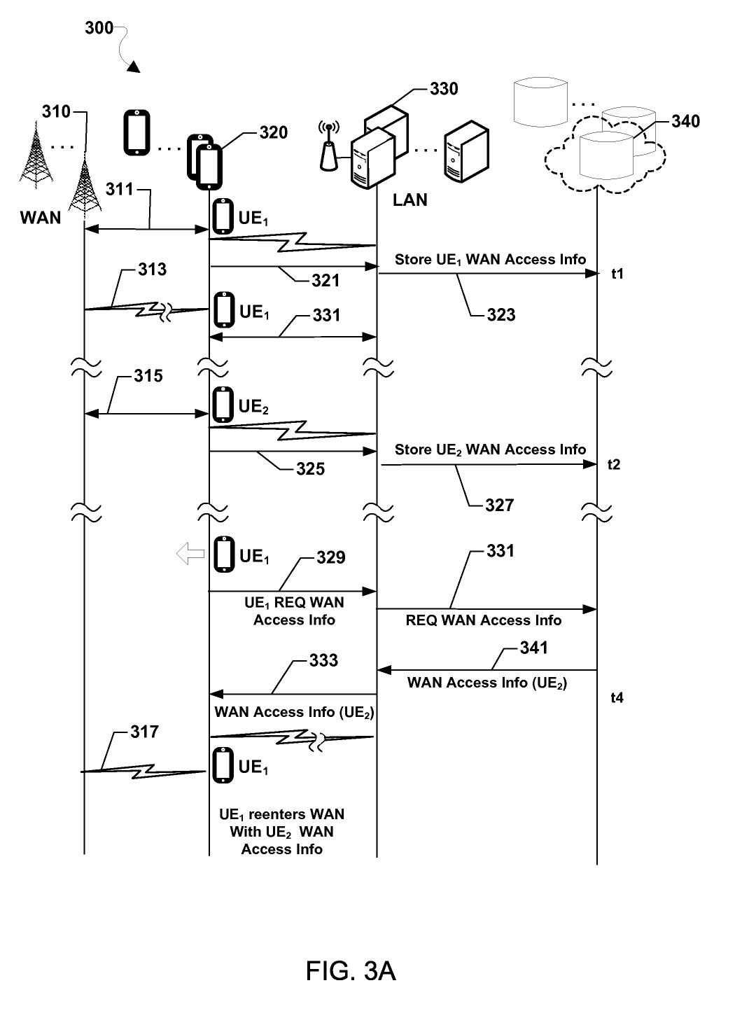

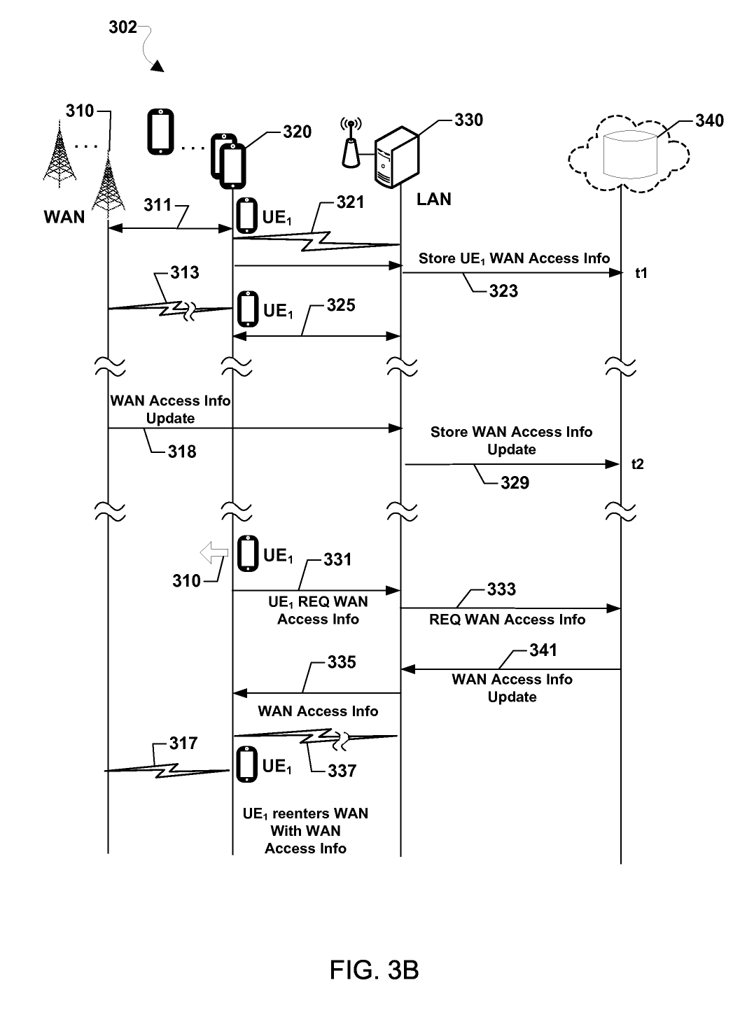

Aspects of the various embodiments may be further understood with reference to the message flows shown in FIG. 3A-FIG. 3B. As illustrated in FIG. 3A, one or more UE wireless communication devices 320 may be in communication with one or more infrastructure components 310 from one or more systems involving the same or different RATs and/or service providers. For example, one of the UE wireless communication devices 320, may have a connection 311 with one of the infrastructure components 310. The connection 311 may have been established and/or may be maintained based on WAN access information currently in use for the specific RAT and service provider for the WAN. The UE₁ 320 may come within range of a LAN that is coupled to one or more servers 330. The UE₁ 320 may register or otherwise communicate information, including the WAN access information, to a LAN server 330 with a message 321. The message 321 may be associated with the establishment of the LAN connection with the UE₁ 320. The format of the packet or message 321 may be according to a protocol for the LAN (e.g., P2P, IP, etc.). For example, the message 321 may be a packet that identifies the UE₁ 320 to the LAN or LAN server 330 and contains the WAN access information used during the connection 311. Alternatively, the message 321 may be a message containing the WAN access information that is sent after a connection between the UE₁ 320 and the LAN or LAN server 330 has been established.

The server 330 may receive the WAN access information from the UE₁ 320 and provide the information to one or more storage devices 340, such as cloud storage devices that are accessible to the server 330, in a message 323. The message 323 may be a packet that is sent to the cloud storage device or wireless communication devices 340 using a network protocol. Alternatively, the message 323 may represent a system operation that “writes” the WAN access information or commands that the WAN access information be written to a storage address accessible to the server 330. The one or more storage devices 340 may be configured with a database to store the WAN access information. For example, the WAN access information may be indexed by RAT and service provider. In various examples, the same service provider may use the same RAT or different RATs within a particular WAN, different service providers may use the same RAT, and so on. The WAN access information may typically be unique for a given RAT/service provider pair, which may be referred to herein as a WAN “system.” The foregoing procedures may be generally associated with a time “t₁” that refers to a general time when the UE₁ 320 enters or connects with the LAN server 330 and provides the WAN access information. When the UE₁ 320 has provided the WAN access information a network connection 331 may be established between the UE₁ 320 and the LAN or LAN server 330 and communication may be conducted within the LAN. The UE₁ 320 may disable a WAN radio module and terminate a radio connection 313 with the WAN infrastructure component 310.

Later another UE wireless communication device UE₂ 320, which may be in communication with one or more of the infrastructure components 310 may enter the LAN. In the present example the UE₂ 320 may be assumed to be from the same WAN, i.e., may use the same RAT/service provider pair as UE₁ 320. For example, the UE₂ 320, may have a connection 315 with one of the infrastructure components 310 of the same WAN system as UE₁ 320. The connection 315 may have been established and/or may be maintained based on WAN access information currently in use for the specific RAT and service provider for the WAN. The WAN access information may be the same information provided by UE₁ 320 or may be different WAN access information due to the changing WAN access conditions over time. The UE₂ 320 may come within range of the LAN that is coupled to the one or more servers 330. The UE₂ 320 may register or otherwise communicate information, including the WAN access information, to the LAN server 330 with a message 325. The message 325 may be associated with the establishment of the LAN connection with the UE₂ 320. As in the previous example, the format of the packet or message 325 may be according to a protocol for the LAN (e.g., P2P, IP, etc.) and may be a packet that identifies the UE₂ 320 to the LAN or LAN server 330 and contains the most recent WAN access information used during the connection 315. Alternatively, the message 325 may be a message containing the WAN access information that is sent after a connection between the UE₂ 320 and the LAN or LAN server 330 has been established.

The server 330 may receive the WAN access information from the UE₂ 320 and provide the information to one or more storage devices 340, such as cloud storage devices that are accessible to the server 330, in a message 327. The message 327 may be a packet that is sent to the cloud storage device or wireless communication devices 340 using a network protocol. Alternatively, the message 327 may represent a system operation that “writes” the WAN access information or commands that the WAN access information be written to a storage address accessible to the server 330. The one or more storage devices 340 may be configured with a database to store the WAN access information. As in the previous example, the WAN access information may be indexed by RAT and service provider. In the present example, the WAN access information provided by the UE₂ 320 is associated with the same system as the UE₁ 320. In other examples, the UE₂ 320 may be from a different system. In the various embodiments, the system associated with the WAN access information for the UE₂ 320 is the same system as the UE₁ 320. In such as case, the WAN access information provided by the UE₂ 320 may be simply written over the previous WAN access information provided by the UE₁ 320 at time t₁. Overwriting the WAN access information in this manner may ensure that the WAN access information stored in the LAN accessible database reflects the most recent WAN access information. In other embodiments, the WAN access information provided by the UE₂ 320 may be compared against the WAN access information stored in the LAN accessible database to determine whether the information has changed before being stored. The foregoing procedures may be generally associated with a time “t₂” that refers to a general time after t₁ when the UE₂ 320 enters or connects with the LAN server 330 and provides its current WAN access information to the LAN server. As in the previous example, when the UE₂ 320 enters the LAN and provides the WAN access information, a network connection (not shown) may be established between the UE₂ 320 and the LAN or LAN server 330 to enable communications to be conducted within the LAN. The UE₂ 320 may disable a WAN radio module and terminate a radio connection 315 with the WAN infrastructure component 310. The above procedures may be repeated as new UE wireless communication devices 320 enter the LAN from the same or different WANs.

In the various embodiments, due to wireless communication device mobility, one or more of the UE wireless communication devices 320 may leave the LAN, such as the UE₁ 320. The impending departure of the UE₁ 320 from the LAN may be determined in various ways. For example, a user of the UE₁ 320 may interact with a user interface of the wireless communication device to reconnect with the WAN. In other embodiments, the UE₁ 320 may detect a degradation of a signal associated with the LAN and may automatically begin to reestablish a connection with the WAN. In other embodiments, a LAN component may detect a degradation of a signal from the UE₁ 320 that indicates that the UE₁ 320 may be leaving the LAN. In at least some of the above examples, when a probable departure from the LAN is detected or determined, the UE₁ 320 may send a request 329 to the LAN server 330 to obtain recent WAN access information, e.g. the WAN access information stored in the LAN accessible database. The LAN server 330 in response to the request may send a message 331 to one of the storage device 340 to obtain the WAN access information. The message 331 may be in the form of a command, a request, or other mechanism to cause a retrieval of the WAN access information from storage, such as retrieving the WAN access information from a database maintained on one or more of the cloud storage devices 340 that are accessible to the server 330. In response to the request, command or other mechanism, the storage device or wireless communication devices 340 may provide the most recently stored WAN access information (e.g., from UE₂ 320 at time t₂). The server 330 may provide the WAN access information to the UE₁ 320 in a message 333. The UE₁ 320 may reacquire access to the WAN by using the provided WAN access information to communicate with one of the WAN infrastructure components 310, establish a WAN connection 317 and reenter the WAN. The UE₁ 320 may terminate the connection with the LAN.

FIG. 3B illustrates alternative or additional embodiments for providing and storing WAN access information in a LAN accessible storage mechanism. For example, a UE wireless communication device, such as the UE₁ 320 may connect with the LAN or LAN server 330 and provide access information as described above. In alternative embodiments, updates to the WAN access information may be provided directly from a WAN infrastructure component 310 in a message 318. For example, the WAN access information update may be provided in a communication that occurs between the LAN server 330 and the WAN infrastructure component 310 through a network connection. For example, the LAN server 330 and the WAN infrastructure component 310 may be coupled through a backhaul connection or other network connection. In other embodiments, the LAN server 330 and the WAN infrastructure component 310 may be coupled through a radio connection. In other words, components of the LAN, other than UE wireless communication devices, may be configured to receive radio communications associated with the WAN and thereby obtain the latest WAN access information. When the LAN server 330 receives the WAN access information update from the WAN infrastructure component 310, the LAN server 330 may send a message 329 to the one or more storage devices 340 to store the WAN access information update. While the WAN infrastructure component 310 is illustrated as a cellular base station (e.g., eNodeB, etc.) the WAN infrastructure component 310 may include any component associated with WAN infrastructure such as a network management server, or other WAN component. For reentry into the WAN, the UE₁ 320 may use the updated WAN access information stored in the LAN accessible database to reacquire the WAN as described above.

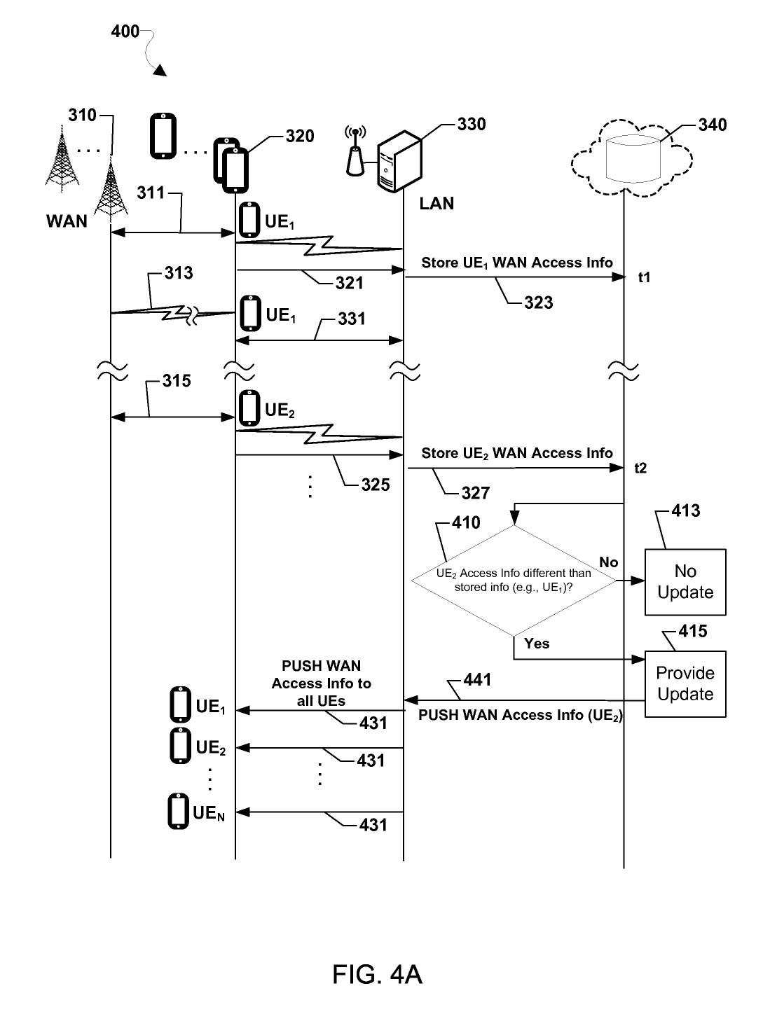

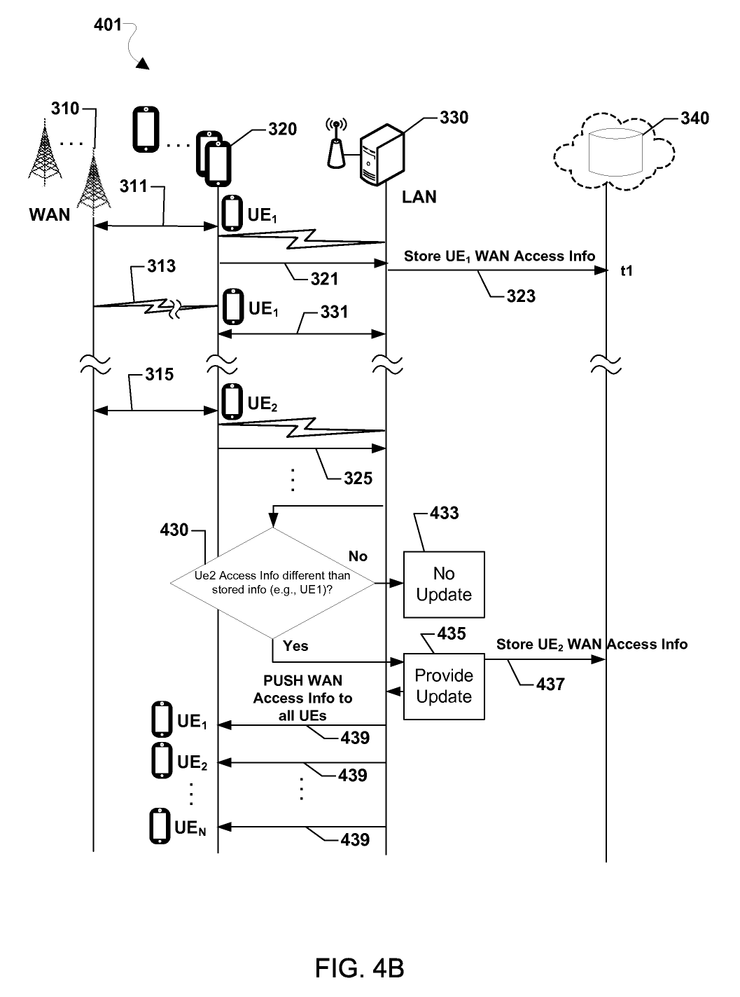

Further embodiments are shown and described in connection with FIG. 4A and FIG. 4B. With reference to FIG. 4A, the UE₁ 320 may enter the LAN at a time t₁ and provide its WAN access information to the LAN server 330, and the UE₂ 320 may enter the LAN at a time t₂ and provide its WAN access information to the LAN server 330 as described above for FIG. 3A. The WAN access information received from the UE₂ 320 may be provided by the LAN server 330 in the message 327. In determination block 410, the data storage device 340 through the operation of a database or other controlling mechanism (such as a processor) may be configured to determine whether the WAN access information provided by the UE₂ 320 differs than the WAN access information stored in the LAN accessible database (e.g., provided by the UE₁ 320 at t₁). In response to determining that the WAN access information provided by the UE₂ 320 is not different (i.e., determination block 410=“No”), the processor associated with the database and/or data storage device 340 may be configured not to provide an update of the WAN access information in block 413. Providing an update may refer to the processor providing the WAN access information to UE wireless communication devices within the LAN, such as through the LAN server 330. Alternatively or additionally, providing an update may refer to the processor updating the database. In some cases, the database may be “updated” meaning that the processor may automatically store the WAN access information in the database, while not providing any information to the UE wireless communication devices.

In response to determining that the WAN access information provided by the UE₂ 320 differs (i.e., determination block 410=“Yes”), the processor associated with the database and/or data storage device 340 may be configured to provide the updated WAN access information in block 415. Providing the update may refer to the processor providing the updated WAN access information to the UE wireless communication devices within the LAN. For example, the processor may provide or “push” the updated WAN access information in a message 441 to the server 330. Alternatively or additionally, providing an update may refer to the processor updating the information in the database. The server 330 may provide or “push” the updated WAN access information to the UE wireless communication device 320, such as UE₁, UE₂, . . . , UE_{N}, in one or more messages 431.

In further embodiments, as illustrated in FIG. 4B, the LAN server 330 may make determinations regarding WAN access information updates. As in previous examples, the UE₁ 320 may enter the LAN at a time t₁ and provide its WAN access information to the LAN server 330, and the UE₂ 320 may enter the LAN at a time t₂ and provide its WAN access information to the LAN server 330 as described above with reference to FIG. 3A and FIG. 4A. The WAN access information from the UE₂ 320 is provided to the LAN server 330 in the message 325. In determination block 430, the LAN server 330 through the operation of a server processor, may be configured to determine whether the WAN access information provided by the UE₂ 320 differs than the WAN access information stored in the LAN accessible database (e.g., provided by the UE₁ 320 at t₁). In response to determining that the WAN access information provided by the UE₂ 320 is not different (i.e., determination block 430=“No”), the processor associated with the server 330 may be configured not to provide an update of the WAN access information in block 433. Providing an update may refer to the server processor providing the WAN access information to UE wireless communication devices within the LAN. Alternatively or additionally, providing an update may refer to the server processor updating the database. In some cases, the database may be “updated” meaning that the processor may automatically store the WAN access information in the database, while not providing any information to the UE wireless communication devices.

In response to determining that the WAN access information provided by the UE₂ 320 differs (i.e., determination block 430=“Yes”), the processor associated with the server 330 may be configured to provide the updated WAN access information in block 435. The server processor may further send the updated WAN access information to the data storage device 340 (e.g., database) in a message 437. Providing the update may refer to the sever processor providing the updated WAN access information to the UE wireless communication devices within the LAN. For example, the server processor may provide or “push” the updated WAN access information to the UE wireless communication device 320, such as UE₁, UE₂, . . . , UE_{N}, in one or more messages 439.

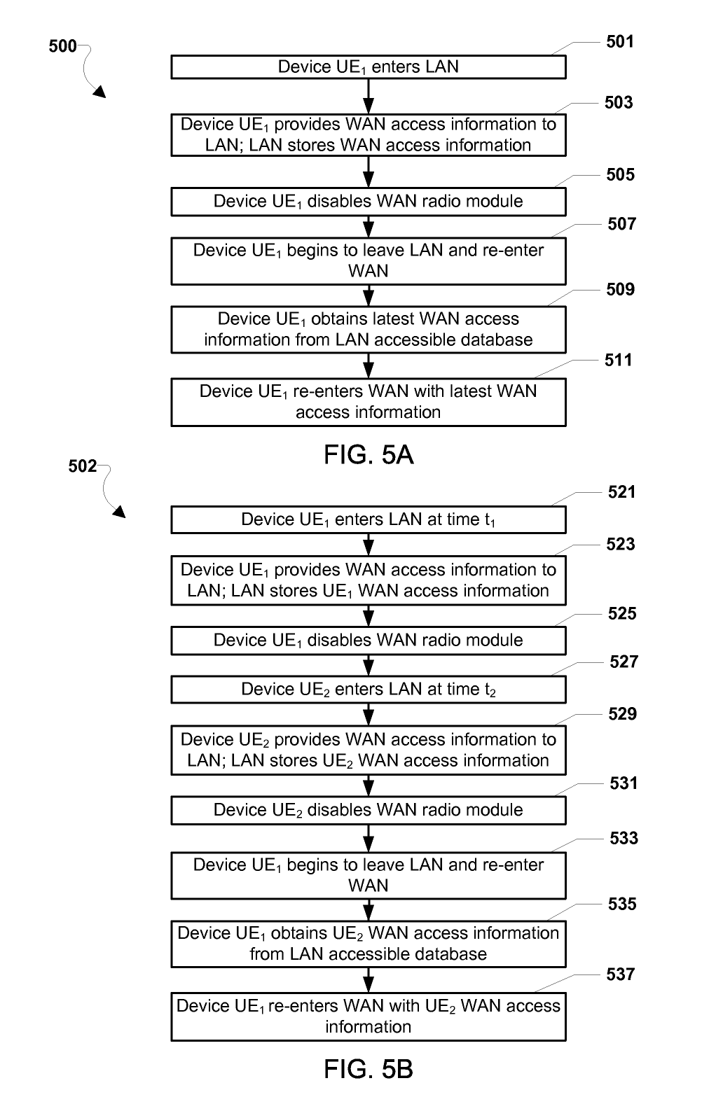

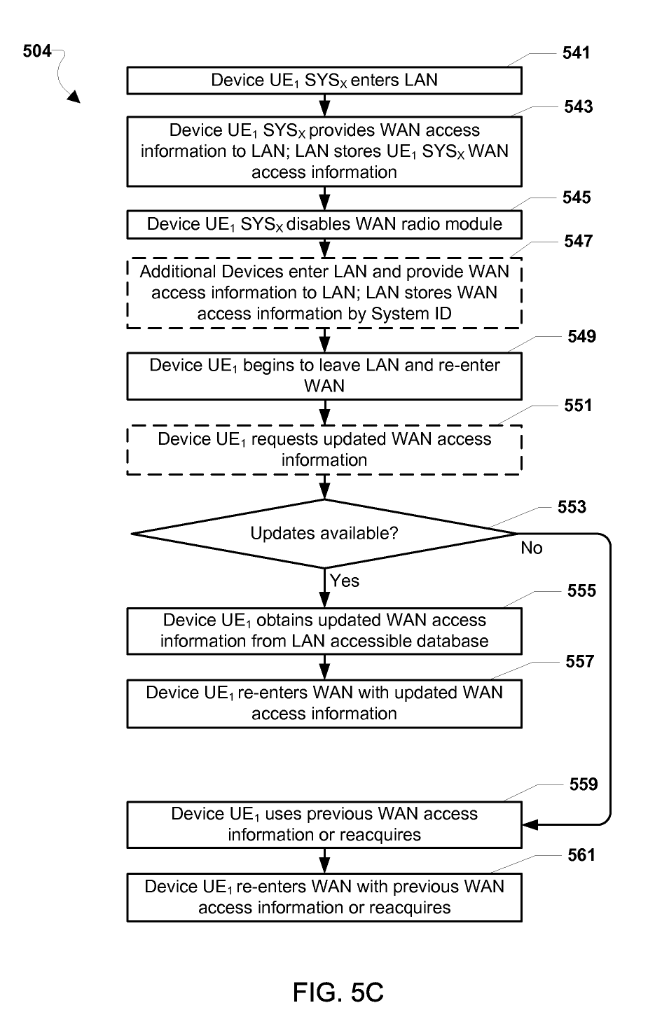

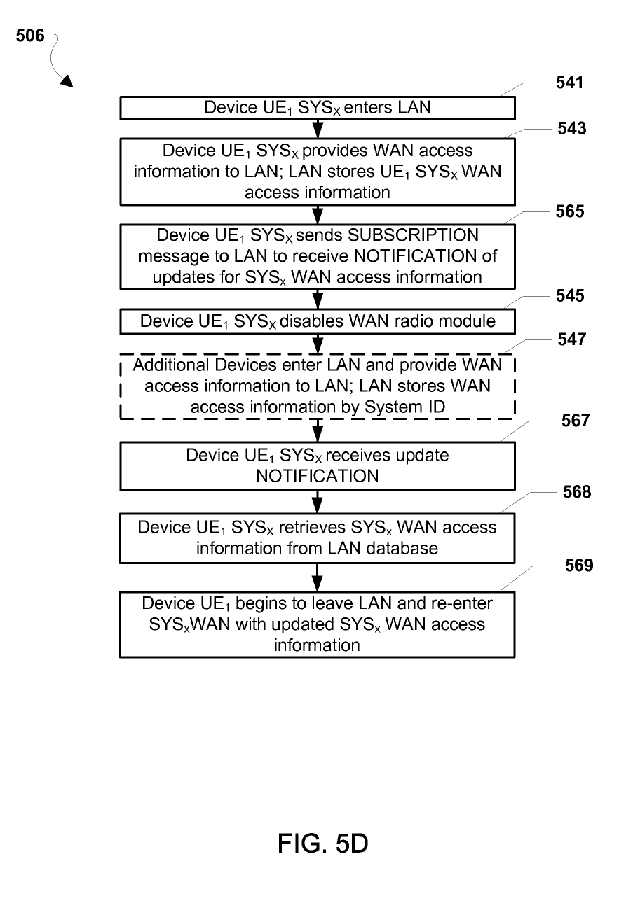

An embodiment method 500 for maintaining WAN access information in a LAN accessible data storage device for facilitating WAN reacquisition by UE wireless communication device that reenter a WAN from a LAN is illustrated in FIG. 5A. In block 501, the wireless communication device processor of a UE wireless communication device (e.g., UE₁) may detect that the wireless communication device has entered a LAN. For example, as the wireless communication device moves it may begin to receive a signal from a LAN access wireless communication device, such as an access point that provides access by the wireless communication device processor to a server associated with the LAN. Alternatively or additionally, the wireless communication device processor may detect other wireless communication devices, such as wireless communication devices associated with LAN, which may include a server.

In block 503, a wireless communication device processor may provide WAN access information to the LAN. For example, in some embodiments, the wireless communication device processor may establish communication and register with the LAN. LAN registration may include providing authentication credentials or LAN other access information. As part of the LAN registration, the wireless communication device processor may provide the WAN access information, which may have been stored by the processor in a memory associated with the UE wireless communication device. In other embodiments, the wireless communication device processor may provide the WAN access information in a communication that occurs after LAN registration.

In block 505, the wireless communication device processor may disable the radio module associated with WAN communication, while maintaining radio communication with the LAN. The wireless communication device processor may advantageously disable or de-energize the WAN radio module in order to conserve battery power and/or to reduce costs associated with maintaining a data connection through the WAN. When the WAN radio module is disabled or de-energized, the wireless communication device processor may no longer receive communication from the WAN, which would ordinarily provide the processor with updates to the WAN access information. Thus, any updates to the WAN access information that occur after the WAN radio is disabled, would ordinarily prevent the wireless communication device from quickly reacquiring and/or camping on the WAN upon WAN reentry.

In block 507, the wireless communication device may begin to leave the LAN and re-enter the WAN. The wireless communication device processor may recognize this is happening by detecting that a signal strength of the LAN signal is degrading, which may indicate that the wireless communication device is leaving the coverage area of the LAN. In other embodiments, the wireless communication device processor may receive a communication from LAN component indicating that the LAN component has detected a degradation in the signal received by the LAN component from the wireless communication device.

In block 509, the wireless communication device processor may obtain the latest WAN access information from the LAN, such as from a LAN server/server processor. The WAN access information may be provided by the LAN server processor from a LAN accessible database or data storage element, such as a cloud storage device. For example, when the wireless communication device processor detects a degradation in the LAN signal, the processor may request and obtain the latest WAN access information from the LAN server/LAN accessible database. Alternatively, the LAN server may provide the latest WAN access information when a LAN component detects a degradation in the signal received from the wireless communication device.

In block 511, the wireless communication device may re-enter the WAN using the latest WAN access information obtained in block 509. For example, the wireless communication device processor may use the overhead information in the latest WAN access information to obtain master information blocks (MIB), system information blocks (SIB), or other overhead information that enables the wireless communication device to immediately acquire access to the WAN and reduce acquisition and/or camping latency.

An embodiment method 502 for obtaining the most recent WAN access information from a LAN accessible database is illustrated in FIG. 5B. In determination block 521, the processor of a UE wireless communication device (e.g., UE₁) may detect that the wireless communication device has entered a LAN at a time t₁. For example, as described above, as a result of mobility, the wireless communication device may begin to receive a signal from a LAN access wireless communication device, such as an access point that provides the wireless communication device processor with access to a server associated with the LAN. Alternatively or additionally, the wireless communication device processor may detect other wireless communication devices, such as wireless communication devices associated with a LAN, which may include a server.

In block 523, the processor of the wireless communication device UE₁ may provide WAN access information to the LAN. For example, in some embodiments, the processor of the wireless communication device UE₁ may establish communication and register with the LAN, such as a LAN server. The LAN server may store the WAN access information provided from the processor of the wireless communication device UE₁. LAN registration may include providing authentication credentials or other LAN access information. As part of the LAN registration, the processor of the wireless communication device UE₁ may provide the WAN access information, which may have been stored by the wireless communication device processor in a memory associated with the UE₁ wireless communication device while the wireless communication device was in communication with the WAN. In other embodiments, the processor of the wireless communication device UE₁ may provide the WAN access information in a communication that occurs after LAN registration.

In block 525, the processor of the wireless communication device UE₁ may disable the radio module associated with WAN communication, while maintaining radio communication with the LAN. The processor of the wireless communication device UE₁ may advantageously disable or de-energize the WAN radio module in order to conserve battery power and/or to reduce costs associated with maintaining a data connection through the WAN. When the WAN radio module is disabled or de-energized, the processor of the wireless communication device UE₁ may no longer receive communication from the WAN, which would ordinarily provide the wireless communication device processor with updates to the WAN access information. Thus, any updates to the WAN access information that occur after the WAN radio is disabled, would ordinarily prevent the processor of the wireless communication device UE₁ from quickly reacquiring the WAN and/or quickly camping on the WAN upon WAN reentry.

In block 527, the wireless communication device processor of a UE wireless communication device (e.g., UE₂) may detect that the wireless communication device UE₂ has entered a LAN at a time t₂. For example, as described above, as a result of mobility, the processor of the wireless communication device UE₂ may begin to receive a signal from a LAN access wireless communication device, such as an access point that provides access by the wireless communication device processor to a server associated with the LAN. Alternatively or additionally, the wireless communication device processor may detect other wireless communication devices, such as wireless communication devices associated with a LAN, which may include a server. At time t2, the wireless communication devices UE₁ and UE₂ are in communication with the LAN.

In block 529, the processor of the wireless communication device UE₂ may provide its WAN access information to the LAN server. The LAN server may store the WAN access information provided from the processor of the wireless communication device UE₂. At time t₂, the WAN access information may be different from the WAN access information stored in the LAN accessible database (e.g., from UE₁), or the WAN access information may be the same. In some embodiments, the processor of the wireless communication device UE₂ may establish communication and register with the LAN. LAN registration may include providing authentication credentials or other LAN access information. As part of the LAN registration, the processor of the wireless communication device UE₂ may provide the latest or most recent WAN access information, which may have been stored by the wireless communication device processor in a memory associated with the UE₂ wireless communication device. In other embodiments, the processor of the wireless communication device UE₂ may provide the WAN access information in a communication that occurs after LAN registration.

In block 531, the processor of the wireless communication device UE₂ may disable the radio module associated with WAN communication, while maintaining radio communication with the LAN. The processor of the wireless communication device UE₂ may advantageously disable or de-energize the WAN radio module in order to conserve battery power and/or to reduce costs associated with maintaining a data connection through the WAN. When the WAN radio module is disabled or de-energized, the processor of the wireless communication device UE₂ may no longer receive communication from the WAN, which would ordinarily provide the wireless communication device processor with updates to the WAN access information. Thus, any updates to the WAN access information that occur after the WAN radio is disabled, would ordinarily prevent the processor of the wireless communication device UE₂ from quickly reacquiring and/or quickly camping on the WAN upon WAN reentry.

In block 533, the processor of the wireless communication device UE₁ may begin to leave the LAN and re-enter the WAN. For example, the processor of the wireless communication device UE₁ may detect that a signal strength of the LAN signal is degrading, which may indicate that the wireless communication device is leaving the coverage area of the LAN. In other embodiments, the processor of the wireless communication device UE₁ may receive a communication from LAN component indicating that the LAN component has detected a degradation in the signal received by the LAN component from the wireless communication device UE₁.

In block 535, the processor of the wireless communication device UE₁ may obtain the latest WAN access information (e.g., UE₂ WAN Access Information) from the LAN, such as from a LAN server/server processor. For example, when the processor of the wireless communication device UE₁ detects a degradation in the LAN signal, the wireless communication device processor may request and obtain the latest WAN access information from the LAN server. The LAN server may obtain the latest WAN access information from a LAN accessible database maintained on a data storage device that may include a cloud storage device. Alternatively, the LAN server may obtain and provide the latest WAN access information when a LAN component detects a degradation in the signal received from the wireless communication device UE₁. After time t₂, the latest WAN access information may be the information provided by the processor of the wireless communication device UE₂ when the wireless communication device UE₂ entered the LAN.

In block 537, the processor of the wireless communication device UE₁ may re-enter the WAN using the latest WAN access information obtained in block 535 (e.g., UE₂ WAN access information). For example, the processor of the wireless communication device UE₁ may use the overhead information in the latest WAN access information to obtain master information blocks (MIB), system information blocks (SIB), or other overhead information that enables the wireless communication device processor to immediately acquire access to the WAN and reduce acquisition latency.

A further embodiment method 504 for obtaining updates of WAN access information is illustrated in FIG. 5C. In determination block 541, the processor of a UE wireless communication device (e.g., UE₁) of a particular WAN system (e.g., SYSₓ) having a particular RAT and service provider, may detect that the wireless communication device has entered a LAN/IoT. For example, as described above, as a result of mobility, the wireless communication device UE₁ SYSₓ may begin to receive a signal from a LAN access wireless communication device, such as an access point that provides access by the wireless communication device processor to a server associated with the LAN. Alternatively or additionally, the processor of the wireless communication device UE₁ SYSₓ may detect other wireless communication devices, such as wireless communication devices associated with a LAN, which may include a server.

In block 543, the processor of the wireless communication device UE₁ SYSₓ may provide WAN access information for the SYSₓ WAN to the LAN. For example, in some embodiments, the processor of the wireless communication device UE₁ SYSₓ may establish communication and register with the LAN, such as a LAN server. The LAN server may store the SYSₓ WAN access information provided from processor of the wireless communication device UE₁ SYSₓ. The WAN access information stored in the LAN accessible database may be indexed by the system ID (e.g., SYSₓ). LAN registration may include providing authentication credentials or other LAN access information. As part of the LAN registration, the processor of the wireless communication device UE₁ SYSₓ may provide the SYSₓ WAN access information, which may have been stored by the processor in a memory associated with the UE₁ SYSₓ wireless communication device while the wireless communication device was in communication with the SYSₓ WAN. In other embodiments, the processor of the wireless communication device UE₁ SYSₓ may provide the SYSₓ WAN access information in a communication that occurs after LAN registration.

In block 545, the processor of the wireless communication device UE₁ SYSₓ may disable the radio module associated with SYSₓ WAN communication, while maintaining radio communication with the LAN. In a multi-system wireless communication device, radio communication with WANs other than the SYSₓ WAN may or may not be maintained. The processor of the wireless communication device UE₁ SYSₓ may advantageously disable or de-energize the SYSₓ WAN radio module in order to conserve battery power and/or to reduce costs associated with maintaining a data connection through the SYSₓ WAN. When the SYSₓ WAN radio module is disabled or de-energized, the processor of the wireless communication device UE₁ SYSₓ may no longer receive communication from the SYSₓ WAN, which would ordinarily provide the wireless communication device processor with updates to the SYSₓ WAN access information. Thus, any updates to the SYSₓ WAN access information that occur after the SYSₓ WAN radio is disabled, would ordinarily prevent the processor of the wireless communication device UE₁ SYSₓ from quickly reacquiring and/or quickly camping on the SYSₓ WAN upon reentry.

In optional block 547, the processor of additional UE wireless communication devices may detect that the respective wireless communication device or wireless communication devices have entered a LAN/IoT. The additional UE wireless communication devices may be from the same or different WAN system as the wireless communication device UE₁ SYSₓ. The additional UE wireless communication devices provide their WAN access information for their respective systems as they enter the LAN in a manner similar to that described in connection with block 543. The LAN server may store the WAN access information provided from processors of the additional wireless communication devices.

In block 549, the processor of the wireless communication device UE₁ SYSₓ may begin to leave the LAN and re-enter the SYSₓ WAN. For example, the processor of the wireless communication device UE₁ SYSₓ may detect that a signal strength of the LAN signal is degrading, which may indicate that the wireless communication device is leaving the coverage area of the LAN. In other embodiments, the processor of the wireless communication device UE₁ SYSₓ may receive a communication from LAN component indicating that the LAN component has detected a degradation in the signal received by the LAN component from the wireless communication device UE₁ SYSₓ.

In block 551, the processor of the wireless communication device UE₁ SYSₓ may optionally request updated access information for the SYSₓ WAN. In some embodiments, the processor of the wireless communication device UE₁ SYSₓ may request updated SYSₓ WAN access information when leaving the LAN. Alternatively or additionally, the processor of the wireless communication device UE₁ SYSₓ may request that updates to SYSₓ WAN access information be automatically provided when available, such as by a LAN server in communication with a LAN accessible database where access information for various WAN systems may be stored.

In determination block 553, the processor of the wireless communication device UE₁ SYSₓ in communication with a LAN component, such as a LAN server processor or a processor associated with a database maintained on a LAN server accessible data storage device (e.g., cloud storage), may determine whether updates to the SYSₓ WAN access information are available. In response to determining that updates to the SYSₓ WAN access information are available (i.e., determination block 553=“Yes”), the processor of the wireless communication device UE₁ SYSₓ may obtain the SYSₓ WAN access information from the LAN server processor and/or database processor in block 555. The processor of the wireless communication device UE₁ SYSₓ may re-enter the SYSₓ WAN using the updated SYSₓ WAN access information in block 557. In response to determining that updates to the SYSₓ WAN access information are not available (i.e., determination block 553=“No”), the processor of the wireless communication device UE₁ SYSₓ may use the SYSₓ WAN access information from the previous communication with the SYSₓ WAN or may reacquire the SYSₓ WAN in block 559. The processor of the wireless communication device UE₁ SYSₓ may reenter the SYSₓ WAN with the previous access information or the acquired access information. However, an acquisition latency may be experienced.

A further embodiment method 506 for sending subscription messages by a UE device to receive a notification of updates of WAN access information is illustrated in FIG. 5D. The operations in blocks 541, 543, 545, and 547 in the method 506 are similar to those of like numbered blocks of the method 504 described above.

In block 565, the processor of the wireless communication device UE₁ SYSₓ may send a subscription message (e.g., request, command, etc.) to the LAN indicating that the device wants to receive a notification of updates to the WAN access information for the SYSₓ WAN. In some embodiments, the notification message may contain the updated WAN access information. In other embodiments, the notification may indicate that the updated information is available, such as in the LAN accessible database.

In block 567, the processor of the wireless communication device UE₁ SYSₓ may receive a notification of an update to the WAN access information for the SYSₓ WAN. For example, the processor of the wireless communication device UE₁ SYSₓ may receive a message, or other communication from a device within the LAN, such as a LAN access point, the LAN accessible database, a LAN server or other device that is in communication with or capable of forwarding a communication to the wireless communication device UE₁ SYSₓ.

In block 568, in response to receiving the notification message, the processor of the wireless communication device UE₁ SYSₓ may retrieve the updated WAN access information for the SYSₓ WAN, such as from the LAN accessible database, or a device connected to the LAN accessible database (e.g., LAN access point, LAN server, etc.). In other embodiments, the notification message may contain the updated WAN access information for the SYSₓ WAN.

In block 569, the processor of the wireless communication device UE₁ SYSₓ may begin to leave the LAN and may re-enter the SYSₓ WAN using the updated SYSₓ WAN access information. As described, by using the updated WAN access information when re-entering the WAN, a device may reduce the access latency, and possibly other latencies, associated with acquiring overhead information from a WAN infrastructure component.

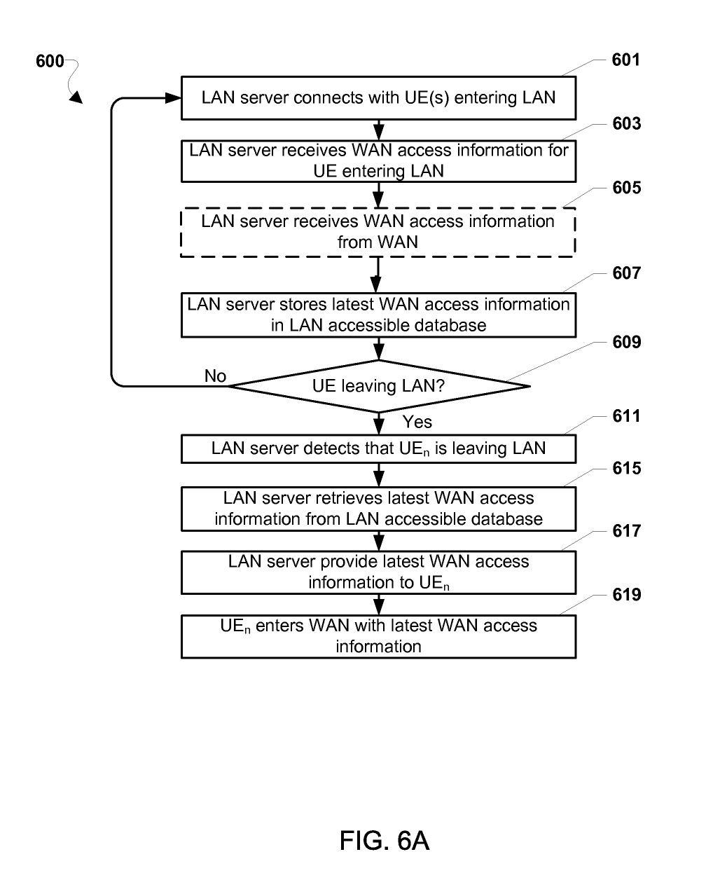

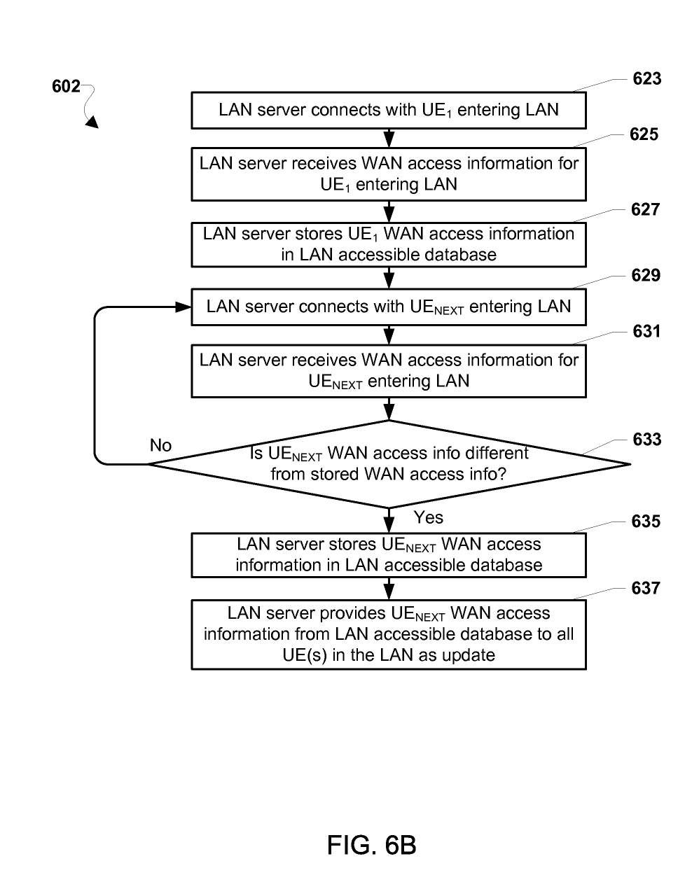

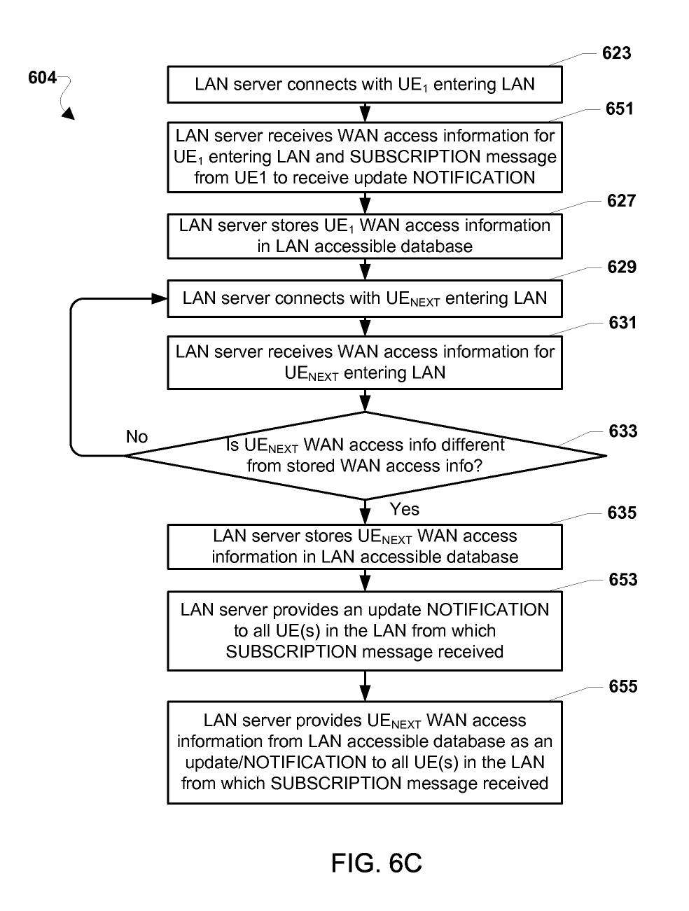

A further embodiment method 600 for a LAN server to maintain a LAN accessible database of WAN access information is illustrated in FIG. 6A. In block 601, a processor of a LAN server may connect with a UE entering the LAN from a WAN. For example, a LAN access point or other LAN component may provide a signal that is received by a UE wireless communication device when the wireless communication device is within range of the LAN component. The UE wireless communication device may respond with registration information including authentication credentials that allow a connection to be established with the LAN server.

In block 603, the server processor may receive WAN access information associated with the UE or UEs that are entering the LAN from one or more WANs. For example, one or more UEs may enter the LAN from the same or different WANs, such as WANs associated with the same or different RATs and/or service providers (e.g., “systems”).

In an optional embodiment, in block 605, the server processor may receive the WAN access information directly from the WAN, such as through a WAN infrastructure component (e.g., eNodeB, network management server, etc.). The WAN access information may be received through communication between the WAN infrastructure component and the server processor. The communication may be conducted through a network or backhaul link, or through a wireless link between the LAN server or LAN component and the WAN infrastructure component.

In block 607, the server processor may store the received WAN access information in a LAN accessible database. For example, the server processor may be coupled to a storage device, such as a cloud storage device. Alternatively or additionally, the server processor may have a local storage device, however such a wireless communication device may nevertheless be considered a “cloud storage device” in at least some embodiments. A database of WAN access information may be maintained on the LAN accessible cloud storage device such that WAN access information may be provided to wireless communication devices that leave the LAN and reenter the WAN as described herein.

In determination block 609, the server processor may determine whether a UE is leaving the LAN. For example, the server processor may be configured to obtain information related to the signal level of the UEs within the LAN. In some cases, the signal level associated with one (or more) of the UEs may drop indicating a probability that the UE is leaving the LAN. In response to determining that a UE is not leaving the LAN (i.e., determination block 609=“No”), the server processor may continue to perform the operations of blocks 601 through 607 for additional UEs that enter the LAN. In response to, or as part of determining that a UE is leaving the LAN (i.e., determination block 609=“Yes”), the server processor may detect the particular UE that is leaving the LAN (e.g., UEₙ) in block 611. Identification by the server processor of the wireless communication device leaving the LAN may be important in order to determine the WAN system to which the wireless communication device may be entering in order to look up the most recent WAN access information relevant to the WAN system for the identified wireless communication device.

In block 615, the server processor may retrieve the latest WAN access information from the LAN accessible database. For example, the server processor may send a message, command, or other communication, to a cloud storage device to obtain the latest WAN access information for the WAN system relevant to the wireless communication device UEₙ. In some embodiments, the latest WAN access information may be assumed to be the most recent access information regardless of whether the information has been updated. In other embodiments, the server processor may refrain from accessing cloud storage in the event the server processor is aware that no updates have occurred to the WAN access information, at least for the particular system relevant to UEₙ.

In block 617, the server processor may provide the obtained latest WAN access information to the UEₙ. For example, the server processor may retrieve and provide the WAN access information in response to the optional request in block 613, or in response to detecting that the UEₙ is leaving the LAN or in response to a combination of conditions. The server processor may provide the WAN access information to the UEₙ before the UEₙ has left the range of the LAN.

In block 619, the UEₙ may enter the WAN using the latest WAN access information provided by the server processor. The UEₙ may terminate the connection with the server processor or the connection may naturally terminate when the UEₙ leaves the range of the LAN.

A further embodiment method 602 for a LAN server to maintain a LAN accessible database of WAN access information and provide updates is illustrated in FIG. 6B. In block 623, a processor of a LAN server may connect with a UE (e.g., UE₁) entering the LAN from a WAN. For example, a LAN access point or other LAN component may provide a signal that is received by the wireless communication device UE₁ when the wireless communication device UE₁ is within range of the LAN component. The wireless communication device UE₁ may respond with registration information including authentication credentials that allow a connection to be established with the LAN server.

In block 625, the server processor may receive WAN access information associated with the wireless communication device UE₁ that enters the LAN from a WAN. For example, the wireless communication device UE₁ may enter the LAN from a WAN associated with a particular RAT and/or service providers (e.g., “system”).

In block 627, the server processor may store the WAN access information received from the wireless communication device UE₁ in a LAN accessible database. For example, the server processor may be coupled to a storage device, such as a cloud storage device. Alternatively or additionally, the server processor may have a local storage device. However, such a wireless communication device may nevertheless be considered a “cloud storage device” in at least some embodiments. A database of WAN access information may be maintained on the LAN accessible cloud storage device such that WAN access information may be provided to wireless communication devices that leave the LAN and reenter the WAN as described herein.

In block 629, the server processor may connect with the next UE that attempts to enter the LAN (e.g., UE_{NEXT}) from a WAN. For example, a LAN access point or other LAN component may provide a signal that is received by the wireless communication device UE_{NEXT} when the wireless communication device UE_{NEXT} is within range of the LAN component. The wireless communication device UE_{NEXT} may respond with registration information including authentication credentials that allow a connection to be established with the LAN server.

In block 631, the server processor may receive WAN access information associated with the wireless communication device UE_{NEXT} that enters the LAN from a WAN. For example, the wireless communication device UE_{NEXT} may enter the LAN from a WAN associated with the same particular RAT and/or service providers (e.g., “system”) from which the wireless communication device UE₁ entered the LAN. In other embodiments, the wireless communication device UE_{NEXT} may enter the LAN from a WAN associated with a different RAN and/or service provider and therefore may be associated with a different system.

In determination block 633, the server processor may determine whether the WAN access information for the wireless communication device UE_{NEXT} differs from relevant stored WAN access information for the system of UE_{NEXT} (e.g., stored UE₁ WAN access information). In response to determining that the WAN access information of UE_{NEXT} is not different from the stored information (i.e., determination block 633=“No”), the server processor may continue to connect with subsequent UE wireless communication devices that enter the LAN in block 629. In other words, in various embodiments, the server processor may not store the WAN access information from the wireless communication device UE_{NEXT}. In other embodiments, the server processor may simply store WAN access information from all UEs that enter the LAN in order to ensure that the latest WAN access information is maintained by the LAN accessible database. In response to determining that the WAN access information of UE_{NEXT} differs from the stored information (i.e., determination block 633=“Yes”), the server processor may store the WAN access information from UE_{NEXT} in the LAN accessible database in block 635.

In block 637, having determined that the WAN access information from UE_{NEXT} differs from the WAN access information stored in the LAN accessible database, the server processor may provide the WAN access information from UE_{NEXT} to all UEs that are within the LAN. Alternatively, the server processor may determine which UEs are using the WAN system associated with the WAN access information from UE_{NEXT} and provide the information only to those UEs that are using the same WAN system. However, it will be appreciated that at least some of the UEs may be configured to use more than one WAN system and therefore have the option to use WAN access information from another WAN system different from the WAN system from which they entered the LAN. Thus in some embodiments, UEs may register all systems to which they have the capability of entering when joining the LAN. In other embodiments, a UE may obtain WAN access information from another UE, such as in a LAN-based wireless communication device-to-wireless communication device communication. In such a case, the server processor may provide WAN access information for all systems to all UEs.

A further embodiment method 604 for a LAN server to maintain a LAN accessible database of WAN access information, receive subscription messages and provide update notifications is illustrated in FIG. 6C. The operations of blocks 623, 627, 631, 633, and 635 in the method 604 are similar to those of like numbered blocks of the method 602 described above.

In block 651, the server processor may receive the WAN access information and a subscription message from the UE₁ entering the LAN. The subscription message may be a message or other communication received by the server processor from the UE1. Alternatively or additionally, the subscription message may be a setting or may be included in other configuration information received by the server processor in connection with the initial entry of the UE1 into the LAN (e.g., during device discovery, etc.). The subscription message may indicate to the server processor that the wireless communication device UE₁ wants to receive a notification of an update or updates to the WAN access information, such as the WAN access information stored in the LAN accessible database.

In block 653, in response to storing WAN access information in the LAN accessible database (e.g., in block 635), the server processor may provide a notification of the update to all UE devices from which subscription messages were received. Alternatively or additionally, in block 655, the server processor may provide the updated WAN access information, e.g., the UE_{NEXT} WAN access information, from the LAN accessible database in the notification as an update/notification to all UE devices from which subscription messages were received. In some embodiments, the operations in block 653 may be optional. For example, the server processor may be configured to provide the WAN access information with or as the notification in block 655, in which case a notification that does not contain the WAN access information may not be required.

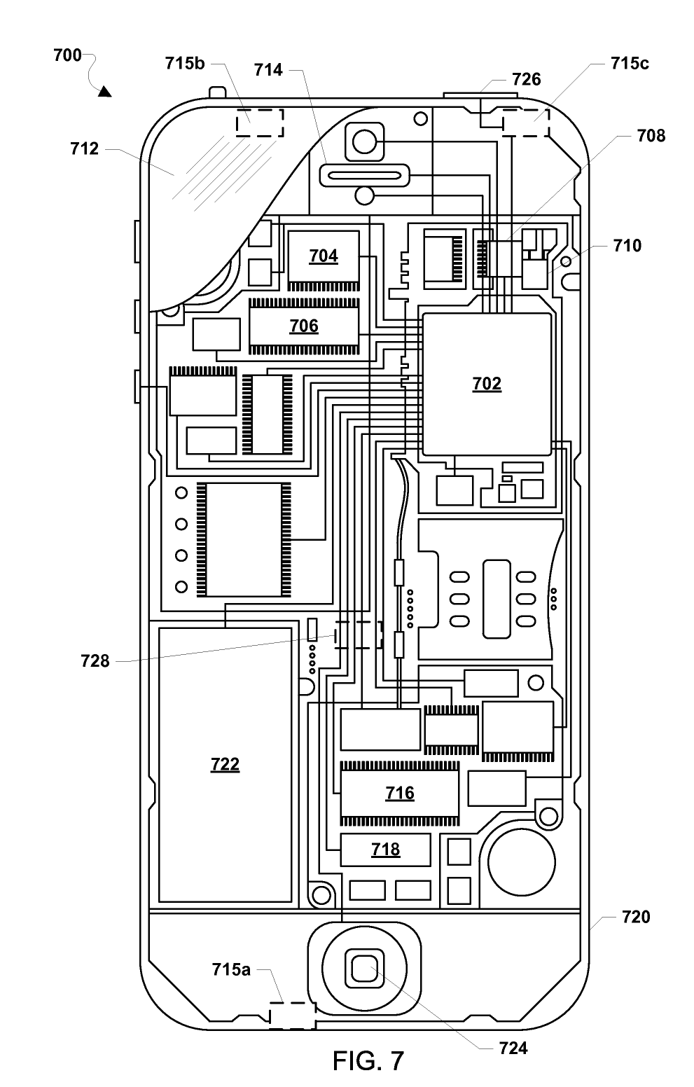

The various aspects, such as performing the operations shown and described in connection with at least FIG. 3A-3B, FIG. 4A-4B, and FIG. 5A-5C, and FIG. 6A-6B, may be implemented in any of a variety of mobile computing wireless communication devices (e.g., smartphones, tablets, etc.) an example of which is illustrated in FIG. 7. The mobile computing wireless communication device 700 may include a processor 702 coupled the various systems of the computing wireless communication device 700 for communication with and control thereof. For example, the processor 702 may be coupled to a touch screen controller 704, radio communication elements, speakers and microphones, and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. In another embodiment (not shown), the computing wireless communication device 700 may also be coupled to an external memory, such as an external hard drive.

The touch screen controller 704 and the processor 702 may also be coupled to a touch screen panel 712, such as a resistive-sensing touch screen, capacitive-sensing touch screen, infrared sensing touch screen, etc. Additionally, the display of the mobile computing wireless communication device 700 need not have touch screen capability. The mobile computing wireless communication device 700 may have one or more radio signal transceivers 708 (e.g., Peanut, Bluetooth, Bluetooth LE, Zigbee, Wi-Fi, RF radio, etc.) and antennae 710, for sending and receiving communications, coupled to each other and/or to the processor 702. The transceivers 708 and antennae 710 may be used with the above-mentioned circuitry to implement the various wireless transmission protocol stacks and interfaces. The mobile computing wireless communication device 700 may include a cellular network wireless modem chip 716 that enables communication via a cellular network and is coupled to the processor.

The mobile computing wireless communication device 700 may include a peripheral wireless communication device connection interface 718 coupled to the processor 702. The peripheral wireless communication device connection interface 718 may be singularly configured to accept one type of connection, or may be configured to accept various types of physical and communication connections, common or proprietary, such as USB, FireWire, Thunderbolt, or PCIe. The peripheral wireless communication device connection interface 718 may also be coupled to a similarly configured peripheral wireless communication device connection port (not shown).

In some embodiments, the mobile computing wireless communication device 700 may include microphones 715. For example, the mobile computing wireless communication device may have a conventional microphone 715a for receiving voice or other audio frequency energy from a user during a call. The mobile computing wireless communication device 700 may further be configured with additional microphones 715b and 715c, which may be configured to receive audio including ultrasound signals. Alternatively, all microphones 715a, 715b, and 715c may be configured to receive ultrasound signals. The microphones 715 may be piezo-electric transducers, or other conventional microphone elements. Because more than one microphone 715 may be used, relative location information may be received in connection with a received ultrasound signal through various triangulation methods. At least two microphones 715 configured to receive ultrasound signals may be used to generate position information for an emitter of ultrasound energy.

The mobile computing wireless communication device 700 may also include speakers 714 for providing audio outputs. The mobile computing wireless communication device 700 may also include a housing 720, constructed of a plastic, metal, or a combination of materials, for containing all or some of the components discussed herein. The mobile computing wireless communication device 700 may include a power source 722 coupled to the processor 702, such as a disposable or rechargeable battery. The rechargeable battery may also be coupled to the peripheral wireless communication device connection port to receive a charging current from a source external to the mobile computing wireless communication device 700. The mobile computing wireless communication device 700 may also include a physical button 724 for receiving user inputs. The mobile computing wireless communication device 700 may also include a power button 726 for turning the mobile computing wireless communication device 700 on and off.

In some embodiments, the mobile computing wireless communication device 700 may further include an accelerometer 728, which senses movement, vibration, and other aspects of the wireless communication device through the ability to detect multi-directional values of and changes in acceleration. In the various embodiments, the accelerometer 728 may be used to determine the x, y, and z positions of the mobile computing wireless communication device 700. Using the information from the accelerometer, a pointing direction of the mobile computing wireless communication device 700 may be detected.

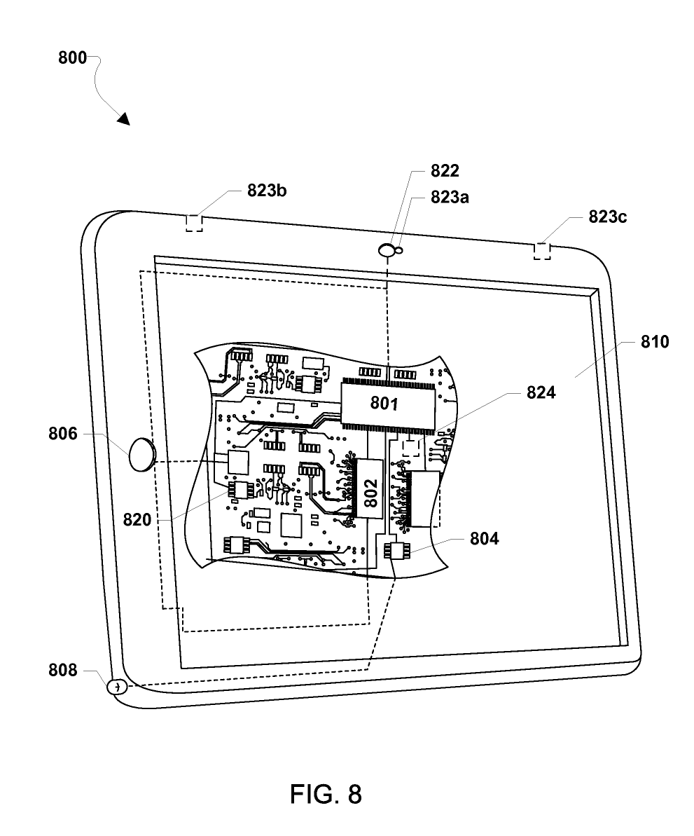

The various embodiments, such as performing the operations shown and described in connection with at least FIG. 3A-3B, FIG. 4A-4B, and FIG. 5A-5C, and FIG. 6A-6B may be implemented in any of a variety of tablet mobile computing wireless communication devices, an example of which is illustrated in FIG. 8. For example, a tablet mobile computing wireless communication device 800 may include a processor 801 coupled to internal memory 802. The internal memory 802 may be volatile or non-volatile memory, and may also be secure and/or encrypted memory, or unsecure and/or unencrypted memory, or any combination thereof. The processor 801 may also be coupled to a touch screen display 810, such as a resistive-sensing touch screen, capacitive-sensing touch screen infrared sensing touch screen, etc. The tablet mobile computing wireless communication device 800 may have one or more radio signal transceivers 804 (e.g., Peanut, Bluetooth, Zigbee, WiFi, RF radio) and antennas 808 for sending and receiving wireless signals as described herein. The transceivers 804 and antennas 808 may be used with the above-mentioned circuitry to implement the various wireless transmission protocol stacks and interfaces. The tablet mobile computing wireless communication device 800 may include a cellular network wireless modem chip 820 that enables communication via a cellular network. The tablet mobile computing wireless communication device 800 may also include a physical button 806 for receiving user inputs. The tablet mobile computing wireless communication device 800 may also include various sensors coupled to the processor 801, such as a camera 822, a microphone or microphones 823, and an accelerometer 824.

For example, the tablet mobile computing wireless communication device 800 may have a conventional microphone 823a for receiving voice or other audio frequency energy from a user during a call or other voice frequency activity. The tablet mobile computing wireless communication device 800 may further be configured with additional microphones 823b and 823c, which may be configured to receive audio including ultrasound signals. Alternatively, all microphones 823a, 823b, and 823c may be configured to receive ultrasound signals. The microphones 823 may be piezo-electric transducers, or other conventional microphone elements. Because more than one microphone 823 may be used, relative location information may be received in connection with a received ultrasound signal through various methods such as time of flight measurement, triangulation, and similar methods. At least two microphones 823 that are configured to receive ultrasound signals may be used to generate position information for an emitter of ultrasound energy.

Also in some embodiments, the tablet mobile computing wireless communication device 800 may further include an accelerometer 824 that senses movement, vibration, and other aspects of the tablet mobile computing wireless communication device 800 through the ability to detect multi-directional values of and changes in acceleration. In the various embodiments, the accelerometer 824 may be used to determine the x, y, and z positions of the tablet mobile computing wireless communication device 800. Using the information from the accelerometer 824, a pointing direction of the tablet mobile computing wireless communication device 800 may be detected.

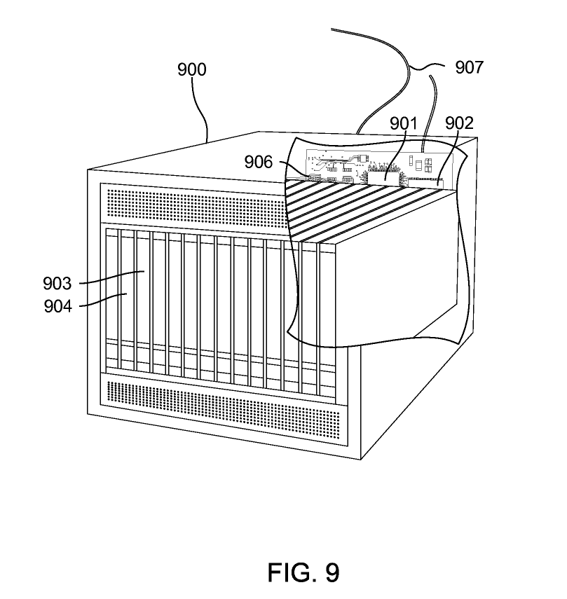

The various embodiments may also be implemented on any of a variety of commercially available servers configured with server-executable instructions to perform the embodiment methods, such as the server 900 illustrated in FIG. 9. Such a server 900 typically includes a processor 901 coupled to volatile memory 902 and a large capacity nonvolatile memory, such as a disk drive 903. The server 900 may also include a floppy disc drive, compact disc (CD) or DVD disc drive 904 coupled to the processor 901. The server 900 may also include network access ports 906 coupled to the processor 901 for establishing network interface connections with a network 907, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 702, 801, and 901 may be any programmable microprocessor, microcomputer or multiple processor chip or chips that can be configured by software instructions (applications) to perform a variety of functions, including the functions of the various embodiments described above. The various operations may be configured to improve the operation of the computer on which they are performed. In some mobile wireless communication devices, multiple processors may be provided, such as one processor dedicated to wireless communication functions and one processor dedicated to running other applications. Typically, software applications may be stored in the internal memory 704, 710, 812, 813, 902, and 903 before they are accessed and loaded into the processors 702, 811, and 901. The processors 702, 811, and 901 may include internal memory sufficient to store the application software instructions. The internal memory may be a volatile or nonvolatile memory, such as flash memory, or a mixture of both. For the purposes of this description, a general reference to memory refers to memory accessible by the processors 702, 811, and 901 including internal memory or removable memory plugged into the server or computing wireless communication device and memory within the server or computing wireless communication device 702, 811, and 901.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic wireless communication device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for using wide area network (WAN) access information maintained in a local area network (LAN) accessible database accessible to a LAN server to assist wireless communication devices in connecting to the WAN, comprising:
determining, by a processor of a wireless communication device connected to the LAN, that the wireless communication device will leave the LAN to enter a WAN associated with the WAN access information;
obtaining, by the processor of the wireless communication device, the WAN access information from the LAN accessible database accessible to the LAN server;
using, by the processor of the wireless communication device, the WAN access information obtained from the LAN accessible database to enter the WAN from the LAN.

2. The method of claim 1, further comprising providing by the processor of the wireless communication device to the LAN server, upon entering the LAN from the WAN, WAN access information used by the wireless communication device in the WAN before entry into the LAN.

3. The method of claim 2, further comprising storing, by the LAN server in the LAN accessible database, the WAN access information used by the wireless communication device in the WAN before entry into the LAN.

4. The method of claim 3, further comprising providing by the processor of the wireless communication device to the LAN server, a subscription message that enables the wireless communication device processor to receive updates to the stored WAN access information.

5. The method of claim 1, further comprising:
receiving, by the LAN server, from wireless communication devices entering the LAN from the WAN, respective WAN access information for the wireless communication devices; and
storing, by the LAN server in the LAN accessible database, the WAN access information received from the wireless communication devices entering the LAN from the WAN.

6. The method of claim 5, further comprising:
determining, by the LAN server, whether the WAN access information most recently received from the wireless communication devices entering the LAN differs from WAN access information stored by the LAN server in the LAN accessible database; and
providing, by the LAN server, recently received WAN access information to one or more of the wireless communication devices in response to determining that the most recently received WAN access information differs from the WAN access information stored in the LAN accessible database.

7. The method of claim 6, further comprising:
receiving, by the LAN server from one or more of the wireless communication devices entering the LAN a subscription message indicating that the one or more of the wireless communication devices will receive a notification of an update of the WAN access information stored in the LAN accessible database; and
providing, by the LAN server, the notification of the update of the WAN access information stored in the LAN accessible database to the one or more of the wireless communication devices from which the subscription message is received in response to determining that the most recently received WAN access information differs from the WAN access information stored in the LAN accessible database.

8. The method of claim 5, further comprising:
determining, by the LAN server, whether the WAN access information most recently received from the wireless communication devices entering the LAN differs from WAN access information stored by the LAN server in the LAN accessible database; and
storing, by the LAN server in the LAN accessible database, the most recently received WAN access information in response to determining that the most recently received WAN access information differs from the WAN access information stored in the LAN accessible database.

9. The method of claim 1, wherein WAN access information comprises one or more of: a Master Information Block (MIB); a System Information Block (SIB); and an overhead (OVHD) block.

10. The method of claim 1, wherein the LAN comprises an Internet of Things (IoT).

11. A wireless communication device, comprising:
a radio module;
a memory; and
a processor coupled to the memory and the radio module, wherein the processor is configured with processor-executable instructions to perform operations for entering a wide area network (WAN) from a local area network (LAN) using WAN access information maintained by a LAN accessible database comprising:
determining that the wireless communication device will leave the LAN to enter the WAN associated with the WAN access information;
obtaining WAN access information from the LAN accessible database; and
using the WAN access information obtained from the LAN accessible storage device to enter the WAN.

12. The wireless communication device of claim 11, wherein the processor is configured with processor-executable instruction to perform operations further comprising providing to a LAN server, upon entering the LAN from the WAN, WAN access information used by the wireless communication device in the WAN before entry into the LAN.

13. The wireless communication device of claim 11, wherein WAN access information comprises one or more of: a Master Information Block (MIB); a System Information Block (SIB); and an overhead (OVHD) block.

14. The wireless communication device of claim 11, wherein the LAN comprises an Internet of Things (IoT).

15. A local area network (LAN) server configured to maintain a LAN accessible database of wide area network (WAN) access information associated with a WAN, the WAN access information for enabling a wireless communication device to enter the LAN from the WAN, the LAN server comprising:
a server processor coupled to the LAN and the LAN accessible database, and the radio module, wherein the server processor is configured with processor-executable instructions to perform operations comprising:
determining whether the wireless communication device will leave the LAN to enter the WAN associated with the WAN access information; and
providing WAN access information from the LAN accessible database to the wireless communication device to enable the wireless communication device to enter the WAN using the provided WAN access information.

16. The LAN server of claim 15, wherein the server processor is configured with processor-executable instruction to perform operations further comprising receiving from the wireless communication device WAN access information used by the wireless communication device in the WAN before entry into the LAN.

17. The LAN server of claim 16, wherein the server processor is configured with processor-executable instruction to perform operations further comprising storing the received WAN access information in the LAN accessible database.

18. The LAN server of claim 15, wherein the server processor is configured with processor-executable instruction to perform operations further comprising:
receiving from wireless communication devices entering the LAN WAN access information used by the wireless communication devices in the WAN before entry into the LAN; and
storing in the LAN accessible database the WAN access information received from wireless communication devices entering the LAN from the WAN.

19. The LAN server of claim 18, wherein the server processor is configured with processor-executable instruction to perform operations further comprising:
determining whether WAN access information received from a wireless communication device entering the LAN from the WAN differs from WAN access information stored in the LAN accessible database; and
providing the received WAN access information to one or more of the wireless communication devices in the LAN in response to determining that the received WAN access information differs from the WAN access information stored in the LAN accessible database.

20. The LAN server of claim 18, wherein the server processor is configured with processor-executable instruction to perform operations further comprising:
determining whether WAN access information received from a wireless communication device entering the LAN from the WAN differs from WAN access information stored in the LAN accessible database; and
storing in the LAN accessible database the received WAN access information in response to determining that the received WAN access information differs from the WAN access information stored in the LAN accessible database.

21. The LAN server of claim 15, wherein WAN access information comprises one or more of: a Master Information Block (MIB); a System Information Block (SIB); and an overhead (OVHD) block.

22. The LAN server of claim 15, wherein the LAN comprises an Internet of Things (IoT).

23. A communication system, comprising:
a local area network (LAN);
a LAN accessible database;
a wireless communication device comprising:
a device radio module configured to communicate with a wide area network (WAN) and the LAN;
a device memory; and
a device processor coupled to the device memory and the device radio module, wherein the device processor is configured with processor-executable instructions to perform operations comprising:
obtaining WAN access information from the LAN accessible database; and
using the WAN access information obtained from the LAN accessible storage database to enter the WAN from the LAN; and
a LAN server device comprising:
a server processor coupled to the LAN and configured with processor-executable instructions to perform operations comprising:
determining that the wireless communication device will leave the LAN to enter the WAN associated with the WAN access information; and
providing WAN access information from the LAN accessible database to the wireless communication device.

24. The communication system of claim 23, wherein the device processor is configured with processor-executable instructions to perform operations further comprising providing to the LAN server, upon entering the LAN from the WAN, WAN access information used by the wireless communication device in the WAN before entry into the LAN.

25. The communication system of claim 23, wherein the server processor is configured with processor-executable instructions to perform operations further comprising storing in the LAN accessible database the WAN access information received from the wireless communication device.

26. The communication system of claim 23, wherein the server processor is configured with processor-executable instructions to perform operations further comprising:
receiving WAN access information from wireless communication devices entering the LAN from the WAN; and
storing in the LAN accessible database the received WAN access information.

27. The communication system of claim 26, wherein the server processor is configured with processor-executable instructions to perform operations further comprising:
determining whether the WAN access information received from a wireless communication device entering the LAN from the WAN differs from WAN access information stored in the LAN accessible database; and
providing the received WAN access information to the wireless communication device in response to determining that the recent WAN access information differs from the WAN access information stored in the LAN accessible database.

28. The communication system of claim 26, wherein the device processor is configured with processor-executable instructions to perform operations further comprising:
determining that the wireless communication device will be entering the WAN from the LAN; and
requesting from the LAN server the recent WAN access information from the wireless communication devices.

29. The communication system of claim 26, wherein the server processor is configured with processor-executable instructions to perform operations further comprising:
determining that the WAN access information received from the wireless communication devices entering the LAN from the WAN differs from WAN access information stored by the LAN server in the LAN accessible database; and
storing in the LAN accessible database, the recent WAN access information in response to determining that the recent WAN access information differs from the WAN access information stored in the LAN accessible database.

30. The communication system of claim 23, wherein WAN access information comprises one or more of: a Master Information Block (MIB); a System Information Block (SIB); and an overhead (OVHD) block.
